(19) United States
(12) Patent Application Publication
(10) Pub. No.: US 2026/0280829 A1
(43) Pub. Date: Sep. 17, 2026

(54) SYSTEMS AND METHODS FOR SIMPLIFICATION OF RESOURCE ALLOCATION IN A COMMUNICATION NETWORK

(71) Applicant: Cable Television Laboratories, Inc., Louisville, CO (US)

(72) Inventors: Lin Cheng, Superior, CO (US); Bernardo Huberman, Palo Alto, CA (US)

(21) Appl. No.: 19/561,951

(22) Filed: Mar. 10, 2026

Related U.S. Application Data
(60) Provisional application No. 63/772,235, filed on Mar. 14, 2025.

(51) Int. Cl. H04L 5/00; H04L 25/02

(52) U.S. Cl. CPC H04L 5/0094; H04L 5/0037; H04L 25/0204

(57) ABSTRACT

A method for simplification of resource allocation in a wireless communication network including a first client, a second client, a first wireless serving device, and a second wireless serving device. The method includes (a) obtaining a plurality of channel estimates from the wireless communication network, (b) for each of the first client and the second client, forming a respective comparative advantage ratio for the client, (c) determining relative values of the respective comparative advantage ratios for the first and second clients, (d) setting to zero either (1) a resource allocation to the second wireless serving device corresponding to the respective comparative advantage ratio for the first client or (2) a resource allocation to the first wireless serving device corresponding to the respective comparative advantage ratio for the second client.

### RELATED APPLICATIONS

This application claims benefit of U.S. Provisional Patent Application No. 63/772,235, filed on Mar. 14, 2025, which is incorporated herein by reference.

### BACKGROUND

In wireless communications, advanced access technologies hold the promise of substantial improvements in network performance. These technologies are critical in addressing the rapidly growing demand for higher data rates, lower latency, increased reliability, AI native interfaces, and co-existing sensing capability. However, despite their theoretical advantages, practical implementation of these access technologies remains a formidable challenge due to multiple technical and economic constraints.

### SUMMARY

Disclosed herein are new systems and methods for simplification of resource allocation in a communication network which help enable advanced access technologies. The new systems and methods apply the economic concept of comparative advantage, which has traditionally been used in trade theory, to simplify resource allocation in a communication network. Comparative advantage suggests that entities should allocate resources where they have the highest relative efficiency, i.e., where they can produce a good or service at a higher efficiency than other entities, and Applicant has found that this heuristic principle can be applied to reduce the dimensionality of complex optimization problems in a communication network. For example, certain embodiments use comparative advantage to identify a lower-dimensional subset of solutions for communication resource optimization instead of solving high-dimensional communication resource optimization problems directly, thereby helping minimize required computational resources and/or required computational time. As another example, certain embodiments determine a variable that quantifies normalized comparative advantage, and these embodiments condition use of comparative advantage on a value of the variable being at least a minimum threshold value, thereby limiting use of comparative advantage to situations where it is particularly advantageous.

In a first aspect, a method for simplification of resource allocation in a wireless communication network including a first client, a second client, a first wireless serving device, and a second wireless serving device includes (a) obtaining a plurality of channel estimates from the wireless communication network, each channel estimate being associated with a respective resource allocation of a matrix of a plurality of feasible resource allocations, (b) for each of the first client and the second client, forming a respective comparative advantage ratio for the client that is an absolute value of a ratio of (1) a channel estimate of the plurality of channel estimates representing response of a communication channel between the client and the first wireless serving device and (2) a channel estimate of the plurality of channel estimates representing response of a communication channel between the client and the second wireless serving device, (c) determining relative values of the respective comparative advantage ratios for the first client and the second client, and (d) in response to a value of the respective comparative advantage ratio for the first client being greater than a value of the respective comparative advantage ratio for the second client, modifying the matrix of the plurality of feasible resource allocations to obtain a simplified resource allocation matrix at least partially by either (1) setting to zero a resource allocation to the second wireless serving device corresponding to the respective comparative advantage ratio for the first client or (2) setting to zero a resource allocation to the first wireless serving device corresponding to the respective comparative advantage ratio for the second client.

In an embodiment of the first aspect, the method further includes transmitting the simplified resource allocation matrix to an optimization system for use by the optimization system in determining an optimum allocation of communication resources in the wireless communication network.

In another embodiment of the first aspect, the matrix of the plurality of feasible resource allocations represents allocation of transmission power to each of the first wireless serving device and the second wireless serving device for each of the first client and the second client.

In another embodiment of the first aspect, the matrix of the plurality of feasible resource allocations represents allocation of wireless spectrum to each of the first wireless serving device and the second wireless serving device for each of the first client and the second client.

In another embodiment of the first aspect, the matrix of the plurality of feasible resource allocations represents allocation of transmission time to each of the first wireless serving device and the second wireless serving device for each of the first client and the second client.

In another embodiment of the first aspect, (a) the wireless communication network operates according to a Third Generation Partnership Project (3GPP) standard, (b) each of the first client and the second client is a respective user equipment (UE) device, and (c) each of the first wireless serving device and the second wireless serving device is a respective wireless base station.

In another embodiment of the first aspect, (a) the wireless communication network operates according to an Institute of Electrical and Electronics Engineers (IEEE) 802.11 standard, (b) each of the first client and the second client is a respective user station, and (c) each of the first wireless serving device and the second wireless serving device is a respective wireless access point (AP).

In a second aspect, a method for simplification of resource allocation in a wireless communication network including N clients, a first wireless serving device, and a second wireless serving device, where Nis an integer greater than one, includes (a) obtaining a plurality of channel estimates from the wireless communication network, each channel estimate being associated with a respective resource allocation of a matrix of a plurality of feasible resource allocations, (b) for each client of the N clients, forming a respective comparative advantage ratio that is an absolute value of a ratio of (1) a channel estimate of the plurality of channel estimates representing response of a communication channel between the client and the first wireless serving device and (2) a channel estimate of the plurality of channel estimates representing response of a communication channel between the client and the second wireless serving device, (c) forming an ordered list of comparative advantage ratios by ordering the respective comparative advantage ratios of the N clients in one of a descending order and an ascending order, each comparative advantage ratio of the ordered list having a respective index q where q ranges from 1 to N, (d) determining a boundary index value I of the ordered list where an optimal resource allocation switches from allocating communication resources to the first wireless serving device to allocating communication resources to the second wireless serving device when optimizing an objective function characterizing the wireless communication network, and (e) modifying the matrix of the plurality of feasible resource allocations to obtain a simplified resource allocation matrix at least partially by (1) setting to zero each resource allocation to the second wireless serving device corresponding to a comparative advantage ratio of the ordered list with a respective index q value that is less than the boundary index value I and (2) setting to zero each resource allocation to the first wireless serving device corresponding to a comparative advantage ratio of the ordered list with a respective index q value that is greater than the boundary index value I In the case where optimizing the objective function includes maximizing the objective function, the objective function satisfies the Inada conditions. In the case where optimizing the objective function includes minimizing the objective function, a negative of the objective function satisfies the Inada conditions.

In an embodiment of the second aspect, the method further includes transmitting the simplified resource allocation matrix to an optimization system for use by the optimization system in determining an optimum allocation of communication resources in the wireless communication network.

In another embodiment of the second aspect, the objective function represents a maximum transmission time in the wireless communication network.

In another embodiment of the second aspect, the matrix of the plurality of feasible resource allocations represents allocation of transmission power to each of the first wireless serving device and the second wireless serving device for each of the N clients.

In another embodiment of the second aspect, the matrix of the plurality of feasible resource allocations represents allocation of wireless spectrum to each of the first wireless serving device and the second wireless serving device for each of the N clients.

In another embodiment of the second aspect, the matrix of the plurality of feasible resource allocations represents allocation of transmission time to each of the first wireless serving device and the second wireless serving device for each of the N clients.

In another embodiment of the second aspect, (a) the wireless communication network operates according to a Third Generation Partnership Project (3GPP) standard, (b) each of the N clients is a respective user equipment (UE) device, and (c) each of the first wireless serving device and the second wireless serving device is a respective wireless base station.

In another embodiment of the second aspect, (a) the wireless communication network operates according to an Institute of Electrical and Electronics Engineers (IEEE) 802.11 standard, (b) each of the N clients is a respective user station, and (c) each of the first wireless serving device and the second wireless serving device is a respective wireless access point (AP).

In a third aspect, a method for simplification of resource allocation in a wireless communication network including a first client, a second client, a first wireless serving device, and a second wireless serving device includes (a) obtaining channel estimates h_{1,1}, h_{1,2}, h_{2,1}, and h_{2,2} from the wireless communication network, h_{1,1} representing response of a communication channel between the first client and the first wireless serving device, h_{1,2} representing response of a communication channel between the first client and the second wireless serving device, h_{2,1} representing response of a communication channel between the second client and the first wireless serving device, and h_{2,2} representing response of a communication channel between the second client and the second wireless serving device, (b) determining a quantifying variable α, where

$$α = \vert \frac{{\vert {h}_{1 , 1} {h}_{2 , 2} \vert}^{2} - {\vert {h}_{1 , 2} {h}_{2 , 1} \vert}^{2}}{{\vert {h}_{1 , 1} {h}_{2 , 2} \vert}^{2} + {\vert {h}_{1 , 2} {h}_{2 , 1} \vert}^{2}} \vert ,$$

(c) comparing a value of α to a predetermined minimum threshold value, and (d) in response to the value of α being at least the predetermined minimum threshold value, modifying a matrix of a plurality of feasible resource allocations to obtain a simplified resource allocation matrix.

In an embodiment of the third aspect, (a) the matrix of a plurality of feasible resource allocations is a matrix F, wherein:

$$F = \begin{matrix}{f}_{1 , 1} & {f}_{1 , 2} \\ {f}_{2 , 1} & {f}_{2 , 2}\end{matrix} , \qquad ( 1 )$$

(2) f_{1,1} is a resource allocated to the first wireless serving device for serving the first client, (3) f_{1,2} is a resource allocated to the second wireless serving device for serving the first client, (4) f_{2,1} is a resource allocated to the first wireless serving device for serving the second client, (5) f_{2,2} is a resource allocated to the second wireless serving device for serving the second client, and (b) modifying the matrix of the plurality of feasible resource allocations to obtain the simplified resource allocation matrix comprises, in response to

$$\vert \frac{{h}_{1 , 1}}{{h}_{1 , 2}} \vert > \vert \frac{{h}_{2 , 1}}{{h}_{2 , 2}} \vert ,$$

(a) setting f_{1,2} to zero and (b) setting f_{2,2} to one.

In another embodiment of the third aspect, (a) the matrix of a plurality of feasible resource allocations is a matrix F, wherein:

$$F = \begin{matrix}{f}_{1 , 1} & {f}_{1 , 2} \\ {f}_{2 , 1} & {f}_{2 , 2}\end{matrix} , \qquad ( 1 )$$

(2) f_{1,1} is a resource allocated to the first wireless serving device for serving the first client, (3) f_{1,2} is a resource allocated to the second wireless serving device for serving the first client, (4) f_{2,1} is a resource allocated to the first wireless serving device for serving the second client, (5) f_{2,2} is a resource allocated to the second wireless serving device for serving the second client, and (b) modifying the matrix of the plurality of feasible resource allocations to obtain the simplified resource allocation matrix comprises, in response to

$$\vert \frac{{h}_{1 , 1}}{{h}_{1 , 2}} \vert > \vert \frac{{h}_{2 , 1}}{{h}_{2 , 2}} \vert ,$$

(a) setting f_{2,1} to zero and (b) setting f_{1,1} to one.

In another embodiment of the third aspect, (a) the matrix of a plurality of feasible resource allocations is a matrix F, wherein:

$$F = \begin{matrix}{f}_{1 , 1} & {f}_{1 , 2} \\ {f}_{2 , 1} & {f}_{2 , 2}\end{matrix} , \qquad ( 1 )$$

(2) f_{1,1} is a resource allocated to the first wireless serving device for serving the first client, (3) f_{1,2} is a resource allocated to the second wireless serving device for serving the first client, (4) f_{2,1} is a resource allocated to the first wireless serving device for serving the second client, (5) f_{2,2} is a resource allocated to the second wireless serving device for serving the second client, and (b) modifying the matrix of the plurality of feasible resource allocations to obtain the simplified resource allocation matrix comprises, in response to

$$\vert \frac{{h}_{2 , 1}}{{h}_{2 , 2}} \vert > \vert \frac{{h}_{1 , 1}}{{h}_{1 , 2}} \vert ,$$

(a) setting f_{2,2} to zero and (b) setting f_{1,2} to one.

In another embodiment of the third aspect, (a) the matrix of a plurality of feasible resource allocations is a matrix F, wherein:

$$F = \begin{matrix}{f}_{1 , 1} & {f}_{1 , 2} \\ {f}_{2 , 1} & {f}_{2 , 2}\end{matrix} , \qquad ( 1 )$$

(2) f_{1,1} is a resource allocated to the first wireless serving device for serving the first client, (3) f_{1,2} is a resource allocated to the second wireless serving device for serving the first client, (4) f_{2,1} is a resource allocated to the first wireless serving device for serving the second client, (5) f_{2,2} is a resource allocated to the second wireless serving device for serving the second client, and (b) modifying the matrix of the plurality of feasible resource allocations to obtain the simplified resource allocation matrix comprises, in response to

$$\vert \frac{{h}_{2 , 1}}{{h}_{2 , 2}} \vert > \vert \frac{{h}_{1 , 1}}{{h}_{1 , 2}} \vert ,$$

(a) setting f_{1,1} to zero and (b) setting f_{2,1} to one.

In another embodiment of the third aspect, the method further includes transmitting the simplified resource allocation matrix to an optimization system for use by the optimization system in determining an optimum allocation of communication resources in the wireless communication network.

In another embodiment of the third aspect, (a) the wireless communication network operates according to a Third Generation Partnership Project (3GPP) standard, (b) each of the first client and the second client is a respective user equipment (UE) device, and (c) each of the first wireless serving device and the second wireless serving device is a respective wireless base station.

In another embodiment of the third aspect, (a) the wireless communication network operates according to an Institute of Electrical and Electronics Engineers (IEEE) 802.11 standard, (b) each of the first client and the second client is a respective user station, and (c) each of the first wireless serving device and the second wireless serving device is a respective wireless access point (AP).

In a fourth aspect, a method for simplification of resource allocation in a wireline communication network including a first client, a second client, a first serving device, and a second serving device includes (a) obtaining a plurality of channel estimates from the wireline communication network, each channel estimate being associated with a respective resource allocation of a matrix of a plurality of feasible resource allocations, (b) for each of the first client and the second client, forming a respective comparative advantage ratio for the client that is an absolute value of a ratio of (1) a channel estimate of the plurality of channel estimates representing response of a communication channel between the client and the first serving device and (2) a channel estimate of the plurality of channel estimates representing response of a communication channel between the client and the second serving device, (c) determining relative values of the respective comparative advantage ratios for the first client and the second client, and (d) in response to a value of the respective comparative advantage ratio for the first client being greater than a value of the respective comparative advantage ratio for the second client, modifying the matrix of the plurality of feasible resource allocations to obtain a simplified resource allocation matrix at least partially by either (1) setting to zero a resource allocation to the second serving device corresponding to the respective comparative advantage ratio for the first client or (2) setting to zero a resource allocation to the first serving device corresponding to the respective comparative advantage ratio for the second client.

In an embodiment of the fourth aspect, the method further includes transmitting the simplified resource allocation matrix to an optimization system for use by the optimization system in determining an optimum allocation of communication resources in the wireline communication network

In another embodiment of the fourth aspect, the wireline communication network operates according to a Data Over Cable Service Interface Specification (DOCSIS) standard.

In another embodiment of the fourth aspect, the wireline communication network operates according to passive optical network (PON) standard.

In a fifth aspect, a method for simplification of resource allocation in a wireline communication network including N clients, a first serving device, and a second serving device, where Nis an integer greater than one, includes (a) obtaining a plurality of channel estimates from the wireline communication network, each channel estimate being associated with a respective resource allocation of a matrix of a plurality of feasible resource allocations, (b) for each client of the N clients, forming a respective comparative advantage ratio that is an absolute value of a ratio of (1) a channel estimate of the plurality of channel estimates representing response of a communication channel between the client and the first serving device and (2) a channel estimate of the plurality of channel estimates representing response of a communication channel between the client and the second serving device, (c) forming an ordered list of comparative advantage ratios by ordering the respective comparative advantage ratios of the N clients in one of a descending order and an ascending order, each comparative advantage ratio of the ordered list having a respective index q where q ranges from 1 to N, (d) determining a boundary index value I of the ordered list where an optimal resource allocation switches from allocating communication resources to the first serving device to allocating communication resources to the second serving device when optimizing an objective function characterizing the communication network, and (e) modifying the matrix of the plurality of feasible resource allocations to obtain a simplified resource allocation matrix at least partially by (1) setting to zero each resource allocation to the second serving device corresponding to a comparative advantage ratio of the ordered list with a respective index q value that is less than the boundary index value I and (2) setting to zero each resource allocation to the first serving device corresponding to a comparative advantage ratio of the ordered list with a respective index q value that is greater than the boundary index value I In the case where optimizing the objective function includes maximizing the objective function, the objective function satisfies the Inada conditions. In the case where optimizing the objective function includes minimizing the objective function, a negative of the objective function satisfies the Inada conditions

In an embodiment of the fifth aspect, the method further includes transmitting the simplified resource allocation matrix to an optimization system for use by the optimization system in determining an optimum allocation of communication resources in the wireline communication network.

In another embodiment of the fifth aspect, the objective function represents a maximum transmission time in the wireline communication network.

In another embodiment of the fifth aspect, the wireline communication network operates according to a Data Over Cable Service Interface Specification (DOCSIS) standard.

In another embodiment of the fifth aspect, the wireline communication network operates according to passive optical network (PON) standard.

In a sixth aspect, a method for simplification of resource allocation in a wireline communication network including a first client, a second client, a first serving device, and a second serving device includes (a) obtaining channel estimates h_{1,1}, h_{1,2}, h_{2,1}, and h_{2,2} from the wireline communication network, h_{1,1} representing response of a communication channel between the first client and the first serving device, h_{1,2} representing response of a communication channel between the first client and the second serving device, h_{2,1} representing response of a communication channel between the second client and the first serving device, and h_{2,2} representing response of a communication channel between the second client and the second serving device, (b) determining a quantifying variable α, where

$$α = \vert \frac{{\vert {h}_{1 , 1} {h}_{2 , 2} \vert}^{2} - {\vert {h}_{1 , 2} {h}_{2 , 1} \vert}^{2}}{{\vert {h}_{1 , 1} {h}_{2 , 2} \vert}^{2} + {\vert {h}_{1 , 2} {h}_{2 , 1} \vert}^{2}} \vert ,$$

(c) comparing a value of α to a predetermined minimum threshold value, and (d) in response to the value of α being at least the predetermined minimum threshold value, modifying a matrix of a plurality of feasible resource allocations to obtain a simplified resource allocation matrix.

In an embodiment of the sixth aspect, (a) the matrix of a plurality of feasible resource allocations is a matrix F, wherein:

$$F = \begin{matrix}{f}_{1 , 1} & {f}_{1 , 2} \\ {f}_{2 , 1} & {f}_{2 , 2}\end{matrix} , \qquad ( 1 )$$

(2) f_{1,1} is a resource allocated to the first serving device for serving the first client, (3) f_{1,2} is a resource allocated to the second serving device for serving the first client, (4) f_{2,1} is a resource allocated to the first serving device for serving the second client, (5) f_{2,2} is a resource allocated to the second serving device for serving the second client, and (b) modifying the matrix of the plurality of feasible resource allocations to obtain the simplified resource allocation matrix comprises, in response to

$$\vert \frac{{h}_{1 , 1}}{{h}_{1 , 2}} \vert > \vert \frac{{h}_{2 , 1}}{{h}_{2 , 2}} \vert ,$$

(a) setting f_{1,2} to zero and (b) setting f_{2,2} to one.

In another embodiment of the sixth aspect, (a) the matrix of a plurality of feasible resource allocations is a matrix F, wherein:

$$F = \begin{matrix}{f}_{1 , 1} & {f}_{1 , 2} \\ {f}_{2 , 1} & {f}_{2 , 2}\end{matrix} , \qquad ( 1 )$$

(2) f_{1,1} is a resource allocated to the first serving device for serving the first client, (3) f_{1,2} is a resource allocated to the second serving device for serving the first client, (4) f_{2,1} is a resource allocated to the first serving device for serving the second client, (5) f_{2,2} is a resource allocated to the second serving device for serving the second client, and (b) modifying the matrix of the plurality of feasible resource allocations to obtain the simplified resource allocation matrix comprises, in response to

$$\vert \frac{{h}_{1 , 1}}{{h}_{1 , 2}} \vert > \vert \frac{{h}_{2 , 1}}{{h}_{2 , 2}} \vert ,$$

(a) setting f_{2,1} to zero and (b) setting f_{1,1} to one.

In another embodiment of the sixth aspect, (a) the matrix of a plurality of feasible resource allocations is a matrix F, wherein:

$$F = \begin{matrix}{f}_{1 , 1} & {f}_{1 , 2} \\ {f}_{2 , 1} & {f}_{2 , 2}\end{matrix} , \qquad ( 1 )$$

(2) f_{1,1} is a resource allocated to the first serving device for serving the first client, (3) f_{1,2} is a resource allocated to the second serving device for serving the first client, (4) f_{2,1} is a resource allocated to the first serving device for serving the second client, (5) f_{2,2} is a resource allocated to the second serving device for serving the second client, and (b) modifying the matrix of the plurality of feasible resource allocations to obtain the simplified resource allocation matrix comprises, in response to

$$\vert \frac{{h}_{2 , 1}}{{h}_{2 , 2}} \vert > \vert \frac{{h}_{1 , 1}}{{h}_{1 , 2}} \vert ,$$

(a) setting f_{2,2} to zero and (b) setting f_{1,2} to one.

In another embodiment of the sixth aspect, (a) the matrix of a plurality of feasible resource allocations is a matrix F, wherein:

$$F = \begin{matrix}{f}_{1 , 1} & {f}_{1 , 2} \\ {f}_{2 , 1} & {f}_{2 , 2}\end{matrix} , \qquad ( 1 )$$

(2) f_{1,1} is a resource allocated to the first serving device for serving the first client, (3) f_{1,2} is a resource allocated to the second serving device for serving the first client, (4) f_{2,1} is a resource allocated to the first serving device for serving the second client, (5) f_{2,2} is a resource allocated to the second serving device for serving the second client, and (b) modifying the matrix of the plurality of feasible resource allocations to obtain the simplified resource allocation matrix comprises, in response to

$$\vert \frac{{h}_{2 , 1}}{{h}_{2 , 2}} \vert > \vert \frac{{h}_{1 , 1}}{{h}_{1 , 2}} \vert ,$$

(a) setting f_{1,1} to zero and (b) setting f_{2,1} to one.

In another embodiment of the sixth aspect, the method further includes transmitting the simplified resource allocation matrix to an optimization system for use by the optimization system in determining an optimum allocation of communication resources in the wireline communication network.

In another embodiment of the sixth aspect, the wireline communication network operates according to a Data Over Cable Service Interface Specification (DOCSIS) standard.

In another embodiment of the sixth aspect, the wireline communication network operates according to passive optical network (PON) standard.

### BRIEF DESCRIPTION OF THE DRAWINGS

FIG. 1 is a schematic diagram of a cellular wireless communication network including a simplification system.

FIG. 2 is a schematic diagram of an alternate embodiment of the FIG. 1 cellular wireless communication network where a radio access network includes only two wireless base stations.

FIG. 3 is a schematic diagram of an alternate embodiment of the FIG. 1 cellular wireless communication network where (a) a radio access network includes only two wireless base stations and (b) two user equipment (UE) devices are omitted.

FIG. 4 is a block diagram of one embodiment of the simplification system of FIG. 1.

FIG. 5 is an illustration of an example of a full resource allocation matrix for the FIG. 1 cellular wireless communication network.

FIG. 6 is an illustration of an example of a full resource allocation matrix for the FIG. 2 cellular wireless communication network.

FIG. 7 is an illustration of an example of a full resource allocation matrix for the FIG. 3 cellular wireless communication network.

FIG. 8 illustrates example comparative advantage ratios for the FIG. 3 cellular wireless communication network.

FIG. 9 illustrates example comparative advantage ratios for the FIG. 2 cellular wireless communication network.

FIG. 10 illustrates example comparative advantage ratios for the FIG. 1 cellular wireless communication network.

FIG. 11 illustrates one example of an ordered list for FIG. 3 cellular wireless communication network.

FIG. 12 illustrates another example of an ordered list for FIG. 3 cellular wireless communication network.

FIG. 13 illustrates one example of an ordered list for FIG. 2 cellular wireless communication network.

FIG. 14 illustrates another example of an ordered list for FIG. 2 cellular wireless communication network.

FIG. 15 illustrates an example of a simplified resource allocation matrix for the FIG. 3 cellular wireless communication network.

FIG. 16 illustrates another example of a simplified resource allocation matrix for the FIG. 3 cellular wireless communication network.

FIG. 17 is an alternative expression of the FIG. 15 simplified resource allocation matrix.

FIG. 18 is an alternative expression of the FIG. 16 simplified resource allocation matrix.

FIG. 19 illustrates an additional example of a simplified resource allocation matrix for the FIG. 3 cellular wireless communication network.

FIG. 20 illustrates a further example of a simplified resource allocation matrix for the FIG. 3 cellular wireless communication network.

FIG. 21 is an alternative expression of the FIG. 19 simplified resource allocation matrix.

FIG. 22 is an alternative expression of the FIG. 20 simplified resource allocation matrix

FIG. 23 illustrates an example of a simplified resource allocation matrix for the FIG. 2 cellular wireless communication network.

FIG. 24 illustrates another example of a simplified resource allocation matrix for the FIG. 2 cellular wireless communication network.

FIG. 25 is a schematic diagram of a Wi-Fi wireless communication network including a simplification system.

FIG. 26 is a schematic diagram of an optical communication network including a simplification system.

FIG. 27 is a schematic diagram of a cable wireline communication network including a simplification system.

FIG. 28 is a flow chart of a method for simplification of resource allocation in a wireless communication network, according to an embodiment.

FIG. 29 is a flow chart of another method for simplification of resource allocation in a wireless communication network, according to an embodiment.

FIG. 30 is a flow chart of an additional method for simplification of resource allocation in a wireless communication network, according to an embodiment.

FIG. 31 is a schematic diagram of an alternate embodiment of the FIG. 3 cellular wireless communication network configured to obtain two simplified resource allocation matrices.

FIG. 32 is a schematic diagram of an alternate embodiment of the FIG. 3 cellular wireless communication network that further includes a decoding order system to support non-orthogonal multiple access (NOMA) and full-rate coordinated multipoint (CoMP) access.

FIG. 33 is a flow chart of a method for simplification of resource allocation in the FIG. 32 wireless communication network, according to an embodiment.

FIG. 34 is a flow chart of another method for simplification of resource allocation in the FIG. 32 wireless communication network, according to an embodiment.

FIG. 35 is a graph illustrating optimum resource allocations from Monte Carlo simulations.

FIG. 36 is a graph of receiver noise power versus percentage of simulation instances that achieved a global optimum resource allocation, when using an embodiment of a method for simplification of resource allocation (“proposed simplification method”).

FIG. 37 is a graph of receiver noise power versus percentage of simulation instances having global optimum on four edges of the FIG. 35 graph, when using the proposed simplification method.

FIG. 38 is a graph of receiver noise power versus average degradation of an objective function value when using the proposed simplification method, relative to simulated value of the objective function at its global optimum.

FIG. 39 is a graph of distance between the two software defined radio (SDR) setups versus a percentage of tested samples from the proposed simplification method that achieved a global optimum resource allocation.

### DEFINITIONS

The following are definitions of certain terms used in this document:

(a) Comparative advantage: an economic theory that explains why an entity benefits from specializing in the production of goods or services that it can produce at a highest relative efficiency, while trading for remaining goods or services.

(b) Serving device: a device that is allocated communication resources to serve one or more clients. Examples of a serving device include, but are not limited to, a wireless base station of a Third Generation Partnership Project (3GPP) wireless communication network, an access point (AP) of an Institute of Electrical and Electronics Engineers (IEEE) 802.11 wireless communication network, a light source of an optical communication network, and a transceiver of a cable wireline communication network.

(c) Client: a device that is served by a serving device. Examples of a client include, but are not limited to, a user equipment (UE) device of a 3GPP wireless communication network, a user station of an IEEE 802.11 wireless communication network, an optical network termination (ONT) of an optical communication network, an optical network unit (ONU) of an optical communication network, and a cable modem (CM) of a cable communication network.

(d) Wireless serving device: a wireless base station of a 3GPP wireless communication network or an access point of an IEEE 802.11 wireless communication network.

(e) Wireless client: a UE device of a 3GPP wireless communication network or a user station of an IEEE 802.11 wireless communication network.

### DETAILED DESCRIPTION OF THE EMBODIMENTS

One of the primary obstacles facing advanced access technologies is the sheer computational complexity of resource allocation and interference management. Modern access methods, such as non-orthogonal multiple access (NOMA), rate-splitting multiple access (RSMA), and integrated sensing and communication (ISAC), require intricate optimization techniques to efficiently allocate power and bandwidth while minimizing interference. Another significant challenge stems from hardware and energy efficiency constraints. Advanced access technologies often rely on sophisticated signal processing techniques, such as successive interference cancellation (SIC) in NOMA and full duplex or joint transmission and reception in coordinated multipoint (CoMP) schemes. While these technologies theoretically improve network capacity, they impose substantial processing burdens on base stations (BSs), user equipment, and backhaul, leading to increased power consumption and latency. Furthermore, implementation of these techniques at scale requires highly efficient hardware capable of handling signal fidelity and computational overhead requirements without introducing excessive digital processing, which remains a critical limitation in real-world deployments. In addition, resource allocation in all access technologies is complicated by multiple intrinsic factors, including shared air-time among different BS-user pairs, the logarithmic relationship between power and efficiency (as dictated by Shannon's theorem), hierarchical network functions, and the presence of inter-cell interference (ICI).

Disclosed herein are new systems and methods for simplification of resource allocation in a communication network which help overcome the aforementioned problems. The new systems and methods apply the economic concept of comparative advantage, which has traditionally been used in trade theory, to simplify resource allocation in a communication network. Comparative advantage suggests that entities should allocate resources where they have the highest relative efficiency, i.e., where they can produce a good or service at a higher efficiency than other entities, and Applicant has found that this heuristic principle can be applied to reduce the dimensionality of complex optimization problems in a communication network. For example, certain embodiments use comparative advantage to identify a lower-dimensional subset of solutions for communication resource optimization instead of solving high-dimensional communication resource optimization problems directly, thereby helping minimize required computational resources and/or required computational time. As another example, certain embodiments determine a variable that quantifies normalized comparative advantage, and these embodiments condition use of comparative advantage on a value of the variable being at least a minimum threshold value, thereby limiting use of comparative advantage to situations where it is particularly advantageous. Although the application of comparative advantage to communication network resource allocation results in a non-analytical solution that may be sub-optimal, the application of comparative advantage to a communication network has potential to significantly simplify computational burdens while maintaining near-optimal performance.

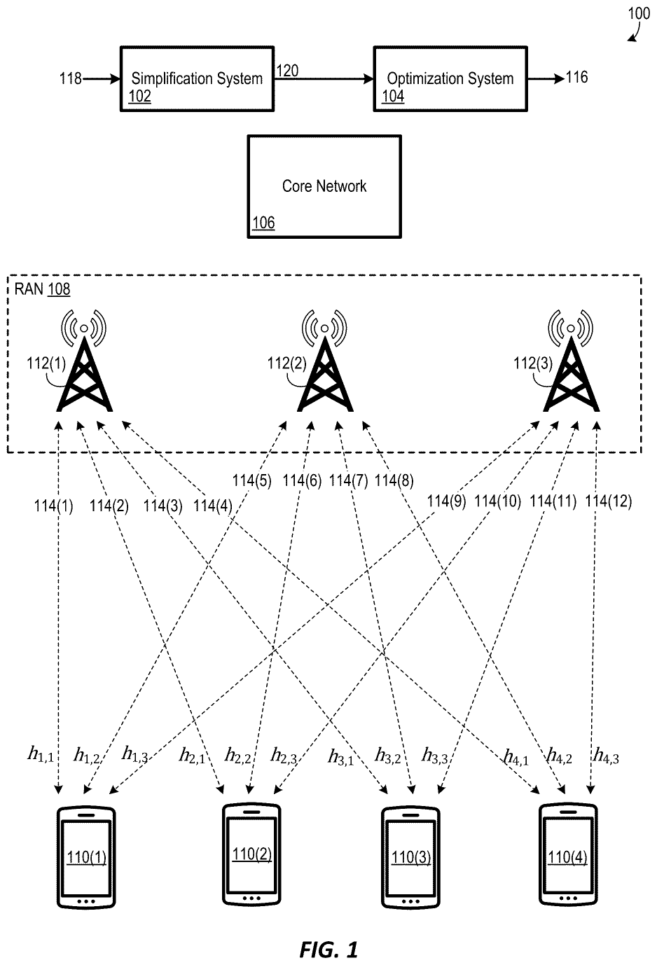

While the new systems and methods are discussed below primarily with respect to cellular wireless communication networks illustrated in FIGS. 1, 2, and 3, it is understood that the new systems and methods could also be applied to other types of communication networks. For example, the new systems and methods could be used in an Institute of Electrical and Electronics Engineers (IEEE) 802.11 wireless communication network, such as a Wi-Fi wireless communication network. As another example, the new systems and methods could be used in a cable wireline communication network (e.g., operating according to a Data Over Cable Service Interface Specification (DOCSIS) standard. As an additional example, the new systems and methods could be used in a passive optical network (PON) wireline communication network.

FIG. 1 is a schematic diagram of a cellular wireless communication network 100 including a simplification system 102, where simplification system 102 is one embodiment of the new systems for simplification of resource allocation in a communication network. Cellular wireless communication network 100 additionally includes an optimization system 104, a core network 106, a radio access network (RAN) 108, and a plurality of clients in the form of user equipment (UE) devices 110. In this document, specific instances of an item may be referred to by use of a numeral in parentheses (e.g. UE device 110(1)) while numerals without parentheses refer to any such item (e.g. UE devices 110). RAN 108 includes a plurality of wireless serving devices in the form of wireless base stations 112. Cellular wireless communication network 100 operates according to a Third Generation Partnership Project (3GPP) standard, and in some embodiments, cellular wireless communication network 100 operates according to one or more of a Fourth Generation (4G) 3GPP standard, a Fifth Generation (5G) 3GPP standard, a Sixth Generation (6G) 3GPP standard, or a successor of any of the foregoing 3GPP standards.

Cellular wireless communication network 100 will typically include additional elements, such as communication links between elements, that are not shown for illustrative simplicity. Additionally, while cellular wireless communication network 100 is illustrated as including four UE devices 110, the quantity of UE devices 110 of cellular wireless communication network 100 may vary. For example, cellular wireless communication network 100 could include a large quantity of UE devices 110 distributed over a large geographic area, or cellular wireless communication network 100 could include as few as two UE devices 110. Additionally, while UE devices 110 are depicted as being mobile phones, UE devices 110 could take other forms, and all UE devices 110 need not be the same type of UE device 110. For example, one or more UE devices 110 could be a computer, a set-top device, a data storage device, an Internet of Things (IoT) device, an entertainment device, a computer networking device, a smartwatch, a wearable device with wireless capability, a medical device, a security device, a monitoring device, and a wireless access device. Similarly, while RAN 108 is illustrated as including three wireless base stations 112, the quantity of wireless base stations 112 in RAN 108 may vary. For example, RAN 108 could include many wireless base stations 112 distributed over a large geographic area. As another example, RAN 108 could include as few as two wireless base stations 112.

FIG. 1 illustrates wireless communication channels 114 between wireless base stations 112 and UE devices 110, which are symbolically shown by dashed-line arrows. In particular, wireless communication channel 114(1) extends between wireless base station 112(1) and UE device 110(1), wireless communication channel 114(2) extends between wireless base station 112(1) and UE device 110(2), and so on. Cellular wireless communication network 100 is configured to generate a respective channel estimate h_{i,j} for each wireless communication channel 114, as depicted in FIG. 1, where (a) i is an index representing a UE device 110 of the wireless communication channel 114 and (b) j is an index representing a wireless base station 112 of the wireless communication channel 114. For example, h_{1,1} is a channel estimate of wireless communication channel 114(1) between UE device 110(1) and wireless base station 112(1). As another example, h_{1,2} is a channel estimate of wireless communication channel 114(5) between UE device 110(1) and wireless base station 112(2). As an additional example, h_{2,1} is a channel estimate of wireless communication channel 114(2) between UE device 110(2) and wireless base station 112(1). Each channel estimate h_{i,j} represents a response of its respective wireless communication channel 114 and accounts for, for example, one or more of path loss of its respective wireless communication channel 114, shadowing of its respective wireless communication channel 114, multipath propagation of its respective wireless communication channel 114, doppler effects of its respective wireless communication channel 114, and noise and/or interference affecting its respective wireless communication channel 114. In certain embodiments, UE devices 110 and/or wireless base stations 112 generate channel estimates h_{i,j}.

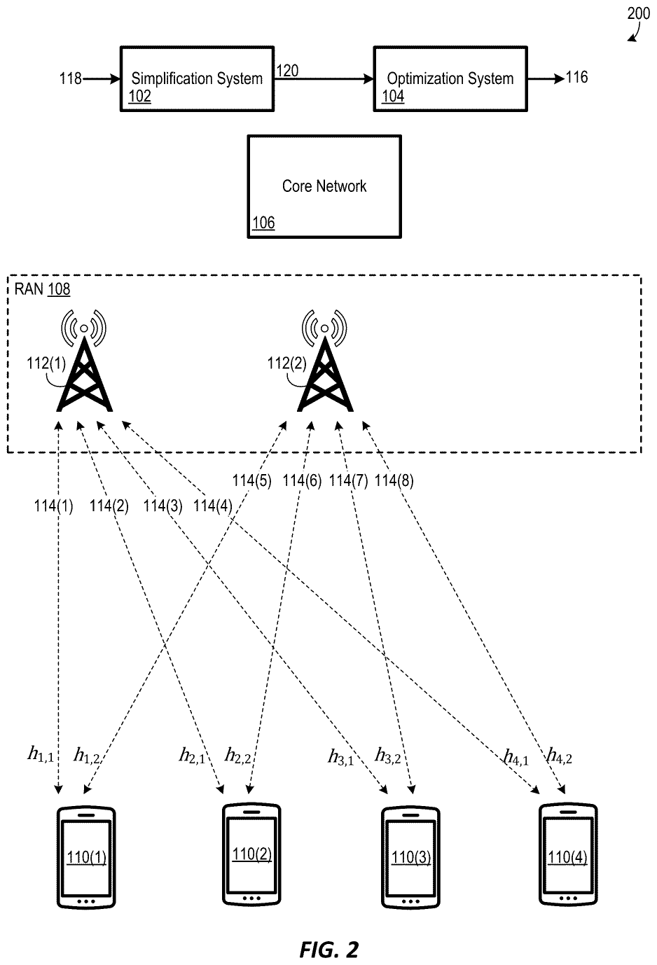

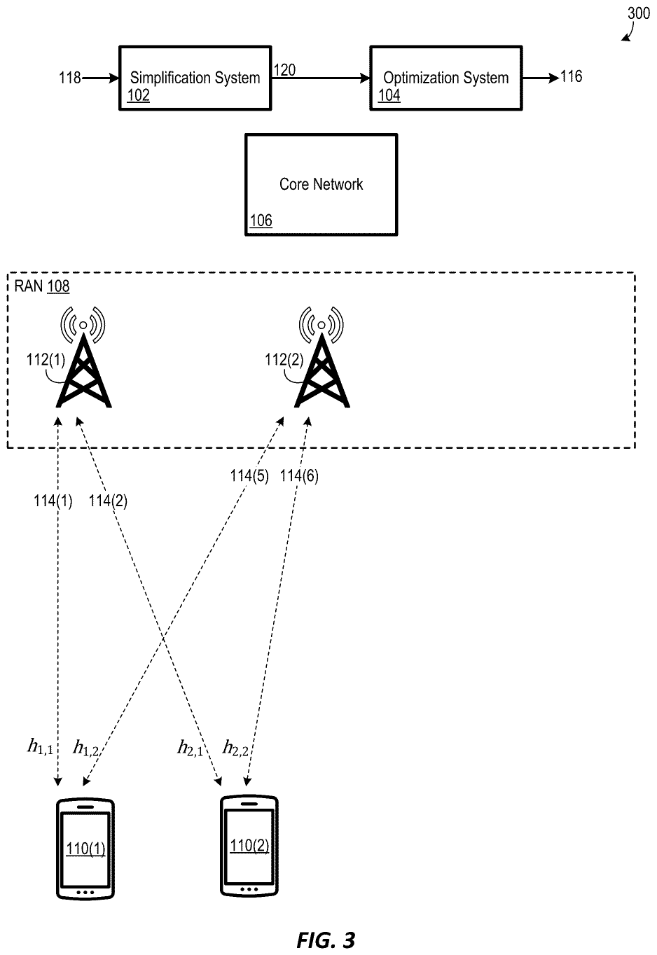

It is understood that the quantity of wireless communication channels 114 and corresponding channel estimates h_{i,j} will change as the quantity of UE devices 110 and/or wireless base stations 112 changes. For example, FIG. 2 is a schematic diagram of a cellular wireless communication network 200, which is an alternate embodiment of cellular wireless communication network 100 where wireless base station 112(3) is omitted. Cellular wireless communication network 200 includes only eight wireless communication channels and corresponding channel estimates h_{i,j} due to wireless base station 112(3) being omitted. As another example, FIG. 3 is a schematic diagram of a cellular wireless communication network 300, which is an alternate embodiment of cellular wireless communication network 100 where each of wireless base station 112(3), UE device 110(3), and UE device 110(4) is omitted. Cellular wireless communication network 300 includes only four wireless communication channels and corresponding channel estimates h_{i,j} due to wireless base station 112(3), UE device 110(3), and UE device 110(4) being omitted.

Referring again to FIG. 1, simplification system 102 is configured to apply comparative advantage to channel estimates h_{i,j} to reduce dimensions of a search space that must be considered by optimization system 104 when optimizing system 104 determines an optimum allocation 116 of communication resources in cellular wireless communication network 100. For example, in certain embodiments, simplification system 102 is configured to use comparative advantage based on channel estimates h_{i,j} to reduce a full resource allocation matrix 118 to a simplified resource allocation matrix 120, where full resource allocation matrix 118 represents all feasible allocations of a given communication resource to wireless base stations 112 and simplified resource allocation matrix 120 is full resource allocation matrix 118 modified so that some feasible resource allocations are replaced with zeros. Simplification system 102 transmits simplified resource allocation matrix 120 to optimization system 104, and optimization system 104 then determines optimum allocation 116 by optimizing an objective function of cellular wireless communication network 100 using non-zero values of simplified resource allocation matrix 120, instead of using full resource allocation matrix 118, as a search space of possible resource allocations, thereby advantageously significantly reducing processing requirements of optimization system 104. While an optimization method used by optimization system 104 may vary as a design choice, examples of possible optimization methods that may be used by optimization system 104 include, but are not limited to, one or more of convex optimization, reinforcement learning, digital twin methods, and game-theoretic methods.

Although simplification system 102 and optimization system 104 are depicted as being separate elements, they may be partially or fully combined. Additionally, one or both of simplification system 102 and optimization system 104 could be part of another element of cellular wireless communication network 100, such as part of core network 106 and/or part of RAN 108. Furthermore, in some alternate embodiments, one or both of simplification system 102 and optimization system 104 are external to cellular wireless communication network 100. In certain embodiments, one or both of simplification system 102 and optimization system 104 are at least partially implemented by one or more processors executing instructions, such as instructions in the form of software and/or firmware, stored in one or more data stores.

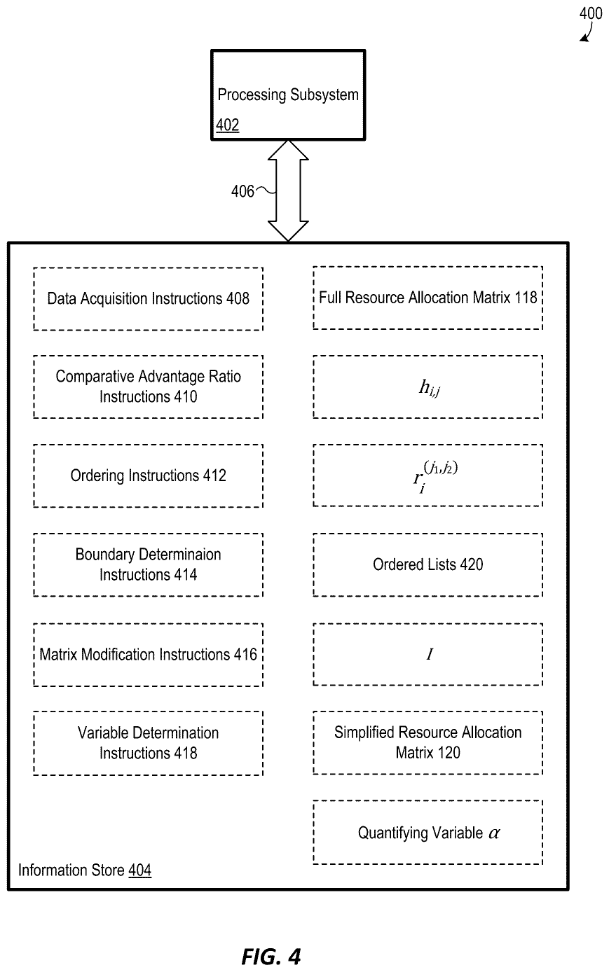

For example, FIG. 4 is a block diagram of a simplification system 400, where simplification system 400 is one embodiment of simplification system 102. However, it is understood that simplification system 102 could be embodied in other manners as long as it performs functions similar to those performed by simplification system 400. Simplification system 400 includes a processing subsystem 402 and an information store 404, where processing subsystem 402 and information store 404 are communicatively coupled as symbolically shown by an arrow 406. Processing subsystem 402 includes one or more processors (not shown), and information store 404 includes, for example, one or more memories, one or more hard drives, and/or one or more databases or other data structures. The elements of simplification system 400 need not be collocated. For example, in certain embodiments, simplification system 400 is at least partially implemented in a distributed computing environment, such as in a cloud computing environment or among multiple computing devices (not shown) of RAN 108. Information store 404 is illustrated as including the following instructions, such as instructions in the form of software and/or firmware, stored therein: (a) data acquisition instructions 408, (b) comparative advantage ratio instructions 410, (c) ordering instructions 412, (d) boundary determination instructions 414, (e) matrix modification instructions 416, and (f) variable determination instructions 418. Additionally, information store 404 is depicted as including the following data: (a) full resource allocation matrix 118, (b) channel estimates h_{i,j}, (c) comparative advantage ratios rᵢ^{(j}^{ₐ}^{,j}^{_{b}}⁾ (d) one or more ordered lists 420, (e) one or more boundary index values I, (f) simplified resource allocation matrix 120, and (g) a quantifying variable α. However, the instructions and data stored in information store 404 could vary. For example, in some alternate embodiments, variable determination instructions 418 and quantifying variable α are each omitted. As another example, in certain alternate embodiments, boundary determination instructions 414 and boundary index values I are omitted.

Processing subsystem 402 is configured to execute instructions stored in information store 404 to generate simplified resource allocation matrix 120 from full resource allocation matrix 118 based on channel estimates h_{i,j} as follows. First, processing subsystem 402 executes data acquisition instructions 408 to obtain full resource allocation matrix 118 and channel estimates h_{i,j} from cellular wireless communication network 100, such as from one or more of core network 106, RAN 108, and UE devices 110. Full resource allocation matrix 118 specifies feasible allocations of a given communication resource for each possible combination of wireless base station 112 and a UE device 110 that is served by the wireless base station. As such, full resource allocation matrix 118 is an N by M matrix, where N is the quantity of UE devices 110 in cellular wireless communication network 100 and Mis the quantity of wireless base stations 112 in cellular wireless communication network 100. Examples of types of communication resources allocated by full resource allocation matrix 118 include, for example, one or more of (a) transmission power allocated to each wireless base station 112 for each UE device 110, (b) wireless spectrum allocated to each wireless base station 112 for each UE device 110, and (c) transmission time allocated to each wireless base station 112 for each UE device 110.

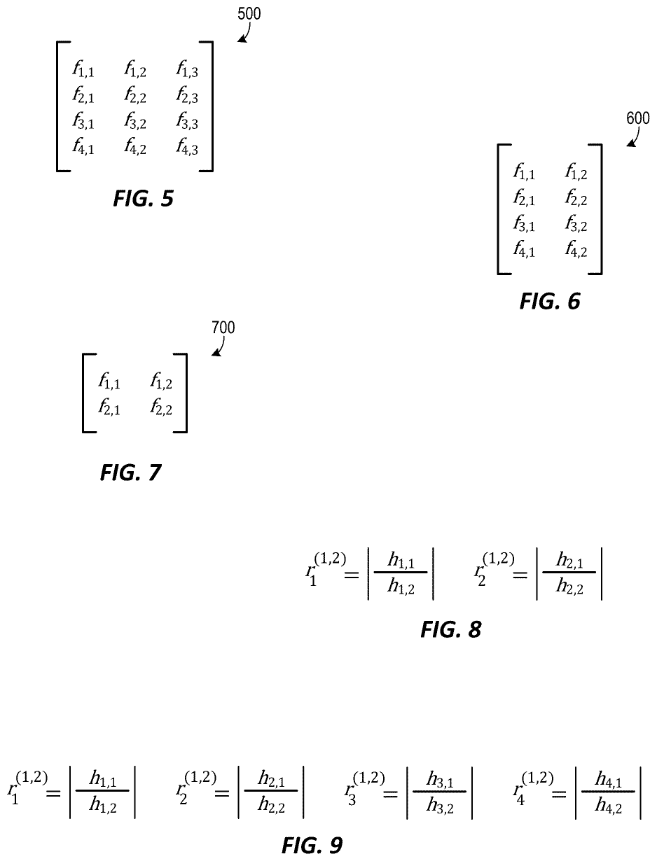

FIG. 5 is an illustration of a full resource allocation matrix 500, where full resource allocation matrix 500 is one example of full resource allocation matrix 118 in cellular wireless communication network 100 of FIG. 1. N is equal to four and M is equal to three in cellular wireless communication network 100, and full resource allocation matrix 500 is therefore a four by three matrix. Full resource allocation matrix 500 includes resource allocations f_{i,j}, where i and j are indexes as discussed above with respect to FIG. 1. Each resource allocation f_{i,j} represents amount of a communication network resource, e.g., transmission power, wireless spectrum, or transmission time, allocated to the j-th wireless base station 112 for the i-th UE device 110. For example, assume that full resource allocation matrix 500 represents feasible allocations of transmission power to wireless base stations 112. In this case, (a) f_{1,1} would represent transmission power allocated to wireless base station 112(1) for UE device 110(1), (b) f_{1,2} would represent transmission power allocated to wireless base station 112(2) for UE device 110(1), (c) f_{1,3} would represent transmission power allocated to wireless base station 112(3) for UE device 110(1), (d) f_{2,1} would represent transmission power allocated to wireless base station 112(1) for UE device 110(2), (e) f_{2,2} would represent transmission power allocated to wireless base station 112(2) for UE device 110(2), (f) f_{2,3} would represent transmission power allocated to wireless base station 112(3) for UE device 110(2), (g) f_{3,1} would represent transmission power allocated to wireless base station 112(1) for UE device 110(3), (h) f_{3,2} would represent transmission power allocated to wireless base station 112(2) for UE device 110(3), (i) f_{3,3} would represent transmission power allocated to wireless base station 112(3) for UE device 110(3), (j) f_{4,1} would represent transmission power allocated to wireless base station 112(1) for UE device 110(4), (k) f_{4,2} would represent transmission power allocated to wireless base station 112(2) for UE device 110(4), and (1) f_{4,3} would represent transmission power allocated to wireless base station 112(3) for UE device 110(4).

Each channel estimate h_{i,j} of cellular wireless communication network 100 is associated with a resource allocation f_{i,j} of full resource allocation matrix 500 with the same indexes i and j as the channel estimate h_{i,j}. For example, channel estimate h_{1,1} is associated with resource allocation f_{1,1} of full resource allocation matrix 500. As another example, channel estimate h_{2,3} is associated with resource allocation f_{2,3} of full resource allocation matrix 500. As an additional example, channel estimate h_{3,2} is associated with resource allocation f_{3,2} of full resource allocation matrix 500.

FIG. 6 is an illustration of a full resource allocation matrix 600, where full resource allocation matrix 600 is one example of full resource allocation matrix 118 in cellular wireless communication network 200 of FIG. 2. Nis equal to four and Mis equal to two in cellular wireless communication network 200, and full resource allocation matrix 600 is therefore a four by two matrix. Full resource allocation matrix 600 includes resource allocations f_{i,j}, analogous to those discussed above with respect to full resource allocation matrix 500 of FIG. 5, although full resource allocation matrix 600 includes fewer resource allocations f_{i,j} than full resource allocation matrix 500 because full resource allocation matrix 600 is only a four by two matrix. In a manner analogous to that discussed above with respect to full resource allocation matrix 500, each channel estimate h_{i,j} of cellular wireless communication network 200 is associated with a resource allocation f_{i,j} of full resource allocation matrix 600 with the same indexes i and j as the channel estimate h_{i,j}.

FIG. 7 is an illustration of a full resource allocation matrix 700, where full resource allocation matrix 700 is one example of full resource allocation matrix 118 in cellular wireless communication network 300 of FIG. 3. Nis equal to two and Mis equal to two in cellular wireless communication network 300, and full resource allocation matrix 700 is therefore a two by two matrix. Full resource allocation matrix 700 includes resource allocations f_{i,j}, analogous to those discussed above with respect to full resource allocation matrix 500 of FIG. 5, although full resource allocation matrix 700 includes fewer resource allocations f_{i,j} than full resource allocation matrix 500 because full resource allocation matrix 700 is only a two by two matrix. In a manner analogous to that discussed above with respect to full resource allocation matrix 500, each channel estimate h_{i,j} of cellular wireless communication network 300 is associated with a resource allocation f_{i,j} of full resource allocation matrix 700 with the same indexes i and j as the channel estimate h_{i,j}.

In certain embodiments, resource allocations f_{i,j} are normalized for each wireless base station 112. For example, in some embodiments, resource allocations f_{i,j} comply with equation (1) below. As such, in these embodiments, the resource allocation values of any given column in a full resource allocation matrix sum to one.

$$F = \{ {( {f}_{i , j} )}_{NXM} : 0 \leq {f}_{i , j} \leq 1 , {Σ}_{i} {f}_{i , j} = 1 \} \qquad ( 1 )$$

Referring again to FIG. 4, processing subsystem 402 executes comparative advantage ratio instructions 410 to generate comparative advantage ratios

$${r}_{i}^{( {j}_{a} , {j}_{b} )}$$

from channel estimates h_{i,j}. Simplification system 400 generates, for each UE device 110, a respective comparative advantage ratio

$${r}_{i}^{( {j}_{1} , {j}_{2} )}$$

for each possible pair of wireless base stations 112 that could serve the UE device 110, where (1) i is an index representing a UE device 110, as discussed above, and (2) (j₁,j₂) indicates a pair of wireless base stations 112 corresponding to the comparative advantage ratio, where j₁ is a first wireless base station 112 of the pair and j₂ is a second wireless base station 112 of the pair. For example, comparative advantage ratio

$${r}_{4}^{( 1 , 2 )}$$

is a comparative advantage ratio for UE device 110(4) for a pair of wireless base stations 112(1) and 112(2). For a given UE device 110, each comparative advantage ratio

$${r}_{i}^{( {j}_{1} , {j}_{2} )}$$

associated with the UE device 110 is an absolute value of a ratio of (a) a channel estimate h_{i,j} associated with one wireless base station 112 that can serve the UE device 110 and (b) a channel estimate h_{i,j} associated with another wireless base station 112 that can serve the UE device 110.

For example, consider cellular wireless communication network 300 of FIG. 3 where each of N and Mis equal to two. There is only one pair (j₁,j₂) of wireless base stations 112 that could serve each UE device 110 in cellular wireless communication network 300, i.e., the pair (1,2) consisting of wireless base stations 112(1) and 112(2). Therefore, simplification system 400 generates two comparative advantage ratios

$${r}_{i}^{( {j}_{1} , {j}_{2} )}$$

for cellular wireless communication network 300, i.e., one comparative advantage ratios

$${r}_{i}^{( {j}_{1} , {j}_{2} )}$$

for each of UE device 110(1) and 110(2) for the pair (1,2) of wireless base stations 112. FIG. 8 illustrates example comparative advantage ratios

$${r}_{i}^{( {j}_{1} , {j}_{2} )}$$

generated by simplification system 400 for cellular wireless communication network 300. Comparative advantage ratio

$${r}_{1}^{( 1 , 2 )}$$

is the absolute value of the ratio of (a) channel estimate h_{1,1} representing response of communication channel 114(1) between UE device 110(1) and wireless base station 112(1) to (b) channel estimate h_{1,2} representing response of communication channel 114(5) between UE device 110(1) and wireless base station 112(2). Comparative advantage ratio

$${r}_{2}^{( 1 , 2 )} ,$$

in turn is the absolute value of the ratio of (a) channel estimate h_{2,1} representing response of communication channel 114(2) between UE device 110(2) and wireless base station 112(1) to (b) channel estimate h_{2,2} representing response of communication channel 114(6) between UE device 110(2) and wireless base station 112(2).

As another example, consider cellular wireless communication network 200 of FIG. 2 where N is equal to four and M is equal to two. Similar to cellular wireless communication network 200 of FIG. 2, there is only one pair (j₁,j₂) of wireless base stations 112 that could serve each UE device 110 in cellular wireless communication network 200, i.e., the pair (1,2) consisting of wireless base stations 112(1) and 112(2). Therefore, simplification system 400 generates four comparative advantage ratios

$${r}_{i}^{( {j}_{1} , {j}_{2} )}$$

for cellular wireless communication network 200, i.e., one comparative advantage ratios

$${r}_{i}^{( {j}_{1} , {j}_{2} )}$$

for each of UE devices 110(1), 110(2), 110(3), and 110(4) for the pair (1,2) of wireless base stations 112. FIG. 9 illustrates example comparative advantage ratios

$${r}_{i}^{( {j}_{1} , {j}_{2} )}$$

generated by simplification system 400 for cellular wireless communication network 200. The comparative advantage ratios

$${r}_{i}^{( {j}_{1} , {j}_{2} )}$$

of FIG. 9 include the two comparative advantage ratios

$${r}_{i}^{( {j}_{1} , {j}_{2} )}$$

of FIG. 8 plus two additional comparative advantage ratios, i.e., comparative advantage ratios

$${r}_{3}^{( 1 , 2 )} and {r}_{4}^{( 1 , 2 )}$$

for UE devices 110(3) and 110(4).

As a further example, consider cellular wireless communication network 100 of FIG. 1 where Nis equal to four and Mis equal to three. In this case, each UE device 110 could be served by three possible pairs (j₁,j₂) of wireless base stations 112. For example, UE device 110(1) could be served by the following pairs of wireless base stations 112: (a) a first pair (1,2) consisting of wireless base stations 112(1) and 112(2), (b) a second pair (2,3) consisting of wireless base stations 112(2) and 112(3), and (c) a third pair (1,3) consisting of wireless base stations 112(1) and 112(3). Similarly, each of UE device 110(2), UE device 110(3), and UE device 110(4) could also be served by the aforementioned three pairs (j₁,j₂) of wireless base stations 112. Consequently, processing subsystem 402 executes comparative advantage ratio instructions 410 to generate twelve comparative advantage ratios

$${r}_{i}^{( {j}_{1} , {j}_{2} )}$$

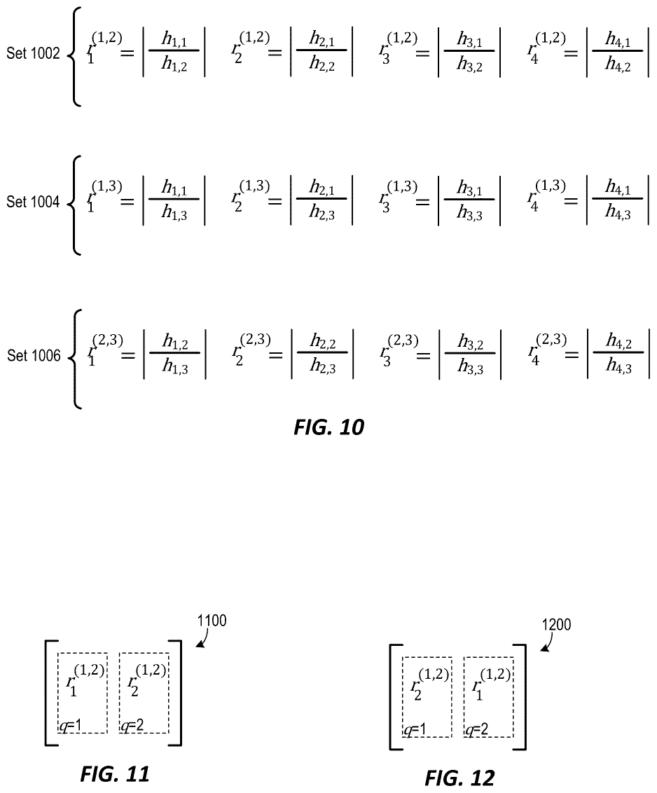

for cellular wireless communication network 100. FIG. 10 illustrates an example of comparative advantage ratios

$${r}_{i}^{( {j}_{1} , {j}_{2} )}$$

generated for cellular wireless communication network 100. Comparative advantageous ratios

$${r}_{i}^{( {j}_{1} , {j}_{2} )}$$

of FIG. 10 may be grouped into the following three sets: (a) a set 1002 for pair of wireless base stations 112(1) and 112(2) that includes comparative advantage ratios

$${r}_{1}^{( 1 , 2 )} , {r}_{2}^{( 1 , 2 )} , {r}_{3}^{( 1 , 2 )} , and {r}_{4}^{( 1 , 2 )} ,$$

(b) a set 1004 for pair of wireless base stations 112(1) and 112(3) that includes comparative advantage ratios

$${r}_{1}^{( 1 , 3 )} , {r}_{2}^{( 1 , 3 )} , {r}_{3}^{( 1 , 3 )} , and {r}_{4}^{( 1 , 3 )} ,$$

and (c) a set 1006 for pair of wireless base stations 112(2) and 112(3) that includes comparative advantage ratios

$${r}_{1}^{( 2 , 3 )} , {r}_{2}^{( 2 , 3 )} , {r}_{3}^{( 2 , 3 )} , and {r}_{4}^{( 2 , 3 )} .$$

It should be noted that the comparative advantage ratios

$${r}_{i}^{( {j}_{1} , {j}_{2} )}$$

of any one of FIG. 8, 9, or 10 could be inverted, i.e., their numerators and denominators could be swapped, as long as all comparative advantage ratios

$${r}_{i}^{( {j}_{1} , {j}_{2} )}$$

of FIG. 8, 9, or 10 are inverted in the same manner. For example, comparative advantage ratios

$${r}_{1}^{( 1 , 2 )} and {r}_{2}^{( 1 , 2 )}$$

of FIG. 8 could be inverted to yield comparative advantage ratios

$${r}_{1}^{( 2 , 1 )} and {r}_{2}^{( 2 , 1 )} , where {r}_{1}^{2 , 1} = \vert \frac{{h}_{1 , 2}}{{h}_{1 , 1}} \vert and {r}_{2}^{2 , 1} \vert \frac{{h}_{2 , 2}}{{h}_{2 , 1}} \vert .$$

Referring again to FIG. 4, processing subsystem 402 executes ordering instructions 412 to form one or more ordered lists 420. In embodiments where Mis equal to two, i.e., where RAN 108 includes only two wireless base stations 112, simplification system 400 forms a single ordered list 420 where comparative advantage ratios

$${r}_{i}^{( {j}_{1} , {j}_{2} )}$$

are ordered according their values in either descending order or ascending order.

For example, consider cellular wireless communication network 300 of FIG. 3 and assume that simplification system 400 generates the example comparative advantage ratios

$${r}_{i}^{( {j}_{1} , {j}_{2} )}$$

for cellular wireless communication network 300 that are illustrated in FIG. 8. Additionally, assume an example scenario where the comparative advantage ratios

$${r}_{i}^{( {j}_{1} , {j}_{2} )}$$

of FIG. 8 have relative values as expressed by inequality (2) below. FIG. 11 illustrates an ordered list 1100, which is one example of an ordered list generated by simplification system 400 for cellular wireless communication network 300 under the aforementioned assumptions. Ordered list 1100 lists comparative advantage ratios

$${r}_{i}^{( {j}_{1} , {j}_{2} )}$$

in descending order, but ordered list 1100 could instead list comparative advantage ratios

$${r}_{i}^{( {j}_{1} , {j}_{2} )}$$

in ascending order. For example, FIG. 12 illustrates an ordered list 1200 which is like ordered list 1100 of FIG. 11 except that comparative advantage ratios

$${r}_{i}^{( {j}_{1} , {j}_{2} )}$$

are listed in ascending order instead of in descending order. Each comparative advantage ratio

$${r}_{i}^{( {j}_{1} , {j}_{2} )}$$

of ordered list 1100 and 1200 has a respective index q as a function of i identifying a position of the comparative advantage ratio

$${r}_{i}^{( {j}_{1} , {j}_{2} )}$$

in the ordered list where index q ranges from 1 to N. For example, the first comparative advantage ratio

$${r}_{1}^{( 1 , 2 )}$$

of ordered list 1100 has an index q value equal to one, and the second comparative advantage ratio

$${r}_{2}^{( 1 , 2 )}$$

of ordered list 1100 has an index q value equal to two. Index q ranges from 1 to 2 in ordered list 1100 and 1200 because cellular wireless communication network 300 includes two UE devices 110.

$$\vert \frac{{h}_{1 , 1}}{{h}_{1 , 2}} \vert > \vert \frac{{h}_{2 , 1}}{{h}_{2 , 2}} \vert \qquad ( 2 )$$

In some alternate embodiments of simplification system 400 where each of N and M is equal to two, processing subsystem 402 executes ordering instructions 412 to determine relative values of the two comparative advantage ratios

$${r}_{i}^{( {j}_{1} , {j}_{2} )} ,$$

e.g., which of the two comparative advantage ratios

$${r}_{i}^{( {j}_{1} , {j}_{2} )}$$

values has a greater or lesser value, instead of forming an ordered list of the comparative advantage ratios

$${r}_{i}^{( {j}_{1} , {j}_{2} )} .$$

For example, consider again cellular wireless communication network 300 of FIG. 3 and assume that simplification system 400 generates the example comparative advantage ratios

$${r}_{i}^{( {j}_{1} , {j}_{2} )}$$

for cellular wireless communication network 300 that are illustrated in FIG. 8. Additionally, assume the example scenario where the comparative advantage ratios

$${r}_{i}^{( {j}_{1} , {j}_{2} )}$$

of FIG. 8 have relative values as expressed by inequality (2) above. In certain alternate embodiments of simplification system 400 under this scenario, processing subsystem 402 executes ordering instructions 412 to determine that the value of comparative advantage ratio

$${r}_{1}^{( 1 , 2 )}$$

is greater than the value of comparative advantage ratio

$${r}_{2}^{( 1 , 2 )} ,$$

or that the value of comparative advantage ratio

$${r}_{2}^{( 1 , 2 )}$$

is lesser than the value of comparative advantage ratio

$${r}_{1}^{( 1 , 2 )} .$$

As another example of forming an ordered list, consider cellular wireless communication network 200 of FIG. 2 and assume that simplification system 400 generates the example comparative advantage ratios

$${r}_{i}^{( {j}_{1} , {j}_{2} )}$$

for cellular wireless communication network 200 that are illustrated in FIG. 9. Additionally, assume an example scenario where the comparative advantage ratios

$${r}_{i}^{( {j}_{1} , {j}_{2} )}$$

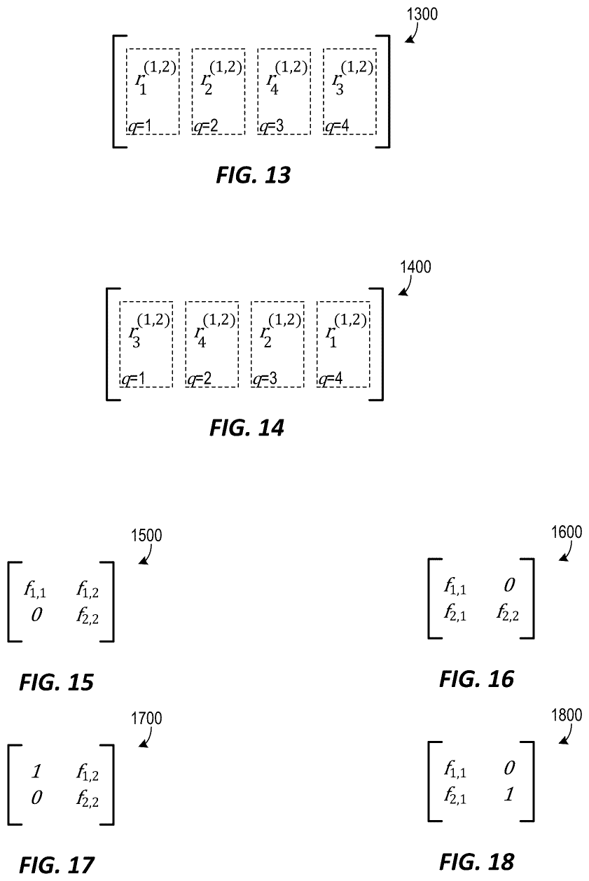

of FIG. 9 have relative values as expressed by inequality (3) below. FIG. 13 illustrates an ordered list 1300, which is one example of an ordered list generated by simplification system 400 for cellular wireless communication network 200 under the aforementioned assumptions. Ordered list 1300 lists comparative advantage ratios

$${r}_{i}^{( {j}_{1} , {j}_{2} )}$$

in descending order, but ordered list 1300 could instead list comparative advantage ratios

$${r}_{i}^{( {j}_{1} , {j}_{2} )}$$

in ascending order. For example, FIG. 14 illustrates an ordered list 1400 which is like ordered list 1300 but with comparative advantage ratios

$${r}_{i}^{( {j}_{1} , {j}_{2} )}$$

listed in ascending order. Each comparative advantage ratio

$${r}_{i}^{( {j}_{1} , {j}_{2} )}$$

of ordered list 1300 and 1400 has a respective index q identifying a position of the comparative advantage ratio

$${r}_{i}^{( {j}_{1} , {j}_{2} )}$$

in the ordered list where index q ranges from 1 to N.

For example, the first comparative advantage ratio

$${r}_{1}^{( 1 , 2 )}$$

of ordered list 1300 has an index q value equal to one, the second comparative advantage ratio

$${r}_{2}^{( 1 , 2 )}$$

of ordered list 1300 has an index q value equal to two, and so on. Index q ranges from 1 to 4 in each of ordered list 1300 and 1400 because cellular wireless communication network 200 includes four UE devices 110.

$$\vert \frac{{h}_{1 , 1}}{{h}_{1 , 2}} \vert > \vert \frac{{h}_{2 , 1}}{{h}_{2 , 2}} \vert > \vert \frac{{h}_{4 , 1}}{{h}_{4 , 2}} \vert > \vert \frac{{h}_{3 , 1}}{{h}_{3 , 2}} \vert \qquad ( 3 )$$

Referring again to FIG. 4, processing subsystem 402 executes boundary determination instructions 414 to determine one or more boundary index values I In cases where Nis greater than two, i.e., where there are three or more UE devices 110, boundary index value I is greater than one but is smaller than N. In cases where N is equal to two, i.e., where there are only two UE devices 110, boundary index value I is either one or two. Additionally, in some embodiments where Nis equal to two, simplification system 400 does not determine any boundary index values I Accordingly, boundary determination instructions 414 are omitted from information store 404 in some embodiments where Nis equal to two.

Boundary index value I represents a value of index q of the ordered list 420 where an optimal resource allocation based on comparative advantage switches from allocating communication resources to one wireless base station 112 to another wireless base station 112, when optimizing an objective function characterizing cellular wireless communication network 200. The objective function can be any function characterizing cellular wireless communication network 200, such as maximum transmission time consumption in the cellular wireless communication network 200, one divided by the logarithm of average signal quality among UE devices 110 in cellular wireless communication network 200, etc. In the case where the objective function is to be maximized, the objective function must satisfy the Inada conditions. In the case where the objective function is to be minimized, a negative of the objective functions must satisfy the Inada conditions. The Inada conditions for a given objective function d(x) are expressed by mathematical statements (4), (5), and (6) below.

$${d}^{′} ( x ) > 0 and {d}^{″} ( x ) < 0 for all x > 0 \qquad ( 4 )$$

$${lim}_{x \to {0}^{+}} {d}^{′} ( x ) = ∞ \qquad ( 5 )$$

$${lim}_{x \to ∞} {d}^{′} ( x ) = 0 \qquad ( 6 )$$

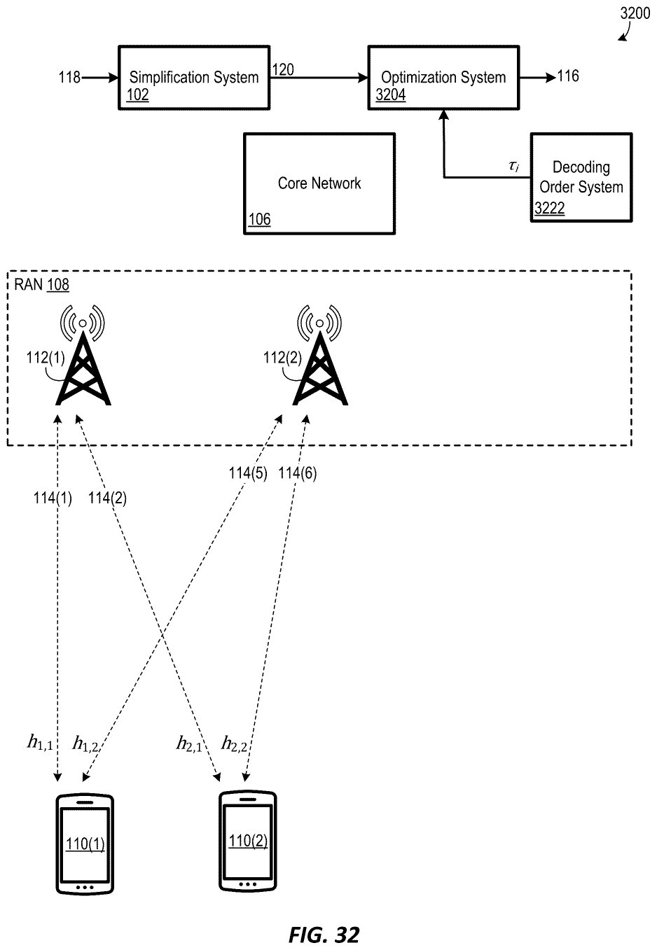

The following is one example of how simplification system 400 may determine boundary index value I in an embodiment of cellular wireless communication network 200 where an objective function to be optimized is an objective function g(x) that is proportional to a longest transmission time among UE devices 110 to finish transmission, where transmission to each UE device 110 is independent. The negative of objective function g(x), i.e. −g(x), satisfies the Inada conditions. It is understood that the communication networks disclosed herein could be configured to optimize a different objective function, as long as the objective function, or a negative of the objective function, satisfies the Inada conditions. For example, some embodiments are configured to optimize an objective function g(η_{τ}) discussed below with respect to FIG. 32.

Assume that (i) full resource allocation matrix 118 of FIG. 2 is full resource allocation matrix 600 and FIG. 6 and (ii) resource allocations f_{i,j} of full resource allocation matrix 600 comply with equation (1) above. Additionally, assume that total received signal-to-interference-plus-noise ratio (SINR) xᵢ for each UE device 110 is specified by equation (7) below, where (a) pⱼ is power density transmitted by the j-th wireless base station 112, as normalized by the noise power density at UE device 110 receivers, and (b) f_{i,j} are the resource allocations of full resource allocation matrix 600.

$${x}_{i} = {Σ}_{1 \leq j \leq M} {\vert {h}_{i , j} \vert}^{2} {p}_{j} {f}_{i , j} 1 \leq i \leq N \qquad ( 7 )$$

Denoting x=(x₁ . . . x_{N}) and assuming xᵢ>0, objective function g(x) may be defined by in equation (8) below, where wᵢ is a relative coefficient that regulates the overall throughput of an i-th UE device 110, e.g., according to a service level agreement (SLA).

$$g ( x ) = {max}_{i} ( \frac{{w}_{i}}{log ( 1 + {x}_{i} )} ) \qquad ( 8 )$$

It is normally desired to minimize transmission time among UE devices 110 to optimize use of transmission time. Accordingly, in this example, objective function g(x) is optimized by finding a SINR vector x that minimizes objective function g(x), as expressed by mathematical expression (12) below.

$$arg {min}_{x} {max}_{i} ( \frac{{w}_{i}}{log ( 1 + {x}_{i} )} ) \qquad ( 9 )$$

Determining a value of vector x that minimizes objective function g(x) is equivalent to determining a resource allocation f_{i,j} of full resource allocation matrix 600 that minimizes objective function g(x) because |h_{i,j}|² and pⱼ are predefined and are coefficients of f_{i,j} in equation (7) above. As such, objective function g(x) can be optimized, i.e., minimized in this example, by finding a resource allocation f_{i,j} of full resource allocation matrix 600 that minimizes objective function g(x). As such, the search space for optimizing objective function g(x) based on full resource allocation matrix 600 is (N−1) by M, or three by two.

Consider |h_{i,j}|²pⱼ, which are the coefficients of f_{i,j} in equation (7). For any UE device 110 pair j₁ and j₂, and for any two UE devices i₁ and i₂, we can assume that inequality (10) below holds.

$$\frac{{\vert {h}_{{i}_{1} , {j}_{1}} \vert}^{2} {p}_{{j}_{1}}}{{\vert {h}_{{i}_{1} , {j}_{2}} \vert}^{2} {p}_{{j}_{2}}} > \frac{{\vert {h}_{{i}_{2} , {j}_{1}} \vert}^{2} {p}_{{j}_{1}}}{{\vert {h}_{{i}_{2} , {j}_{2}} \vert}^{2} {p}_{{j}_{2}}} \qquad ( 10 )$$

Inequality (10) can be simplified to obtain equation inequality (11) as follows:

$$\vert \frac{{h}_{{i}_{1} , {j}_{1}}}{{h}_{{i}_{1} , {j}_{2}}} \vert > \vert \frac{{h}_{{i}_{2} , {j}_{1}}}{{h}_{{i}_{2} , {j}_{2}}} \vert \qquad ( 11 )$$

For brevity, a wireless base station 112 corresponding to index j₁ will henceforth be referred to as wireless base station j₁, and a wireless base station 112 corresponding to index j₂ will henceforth be referred to as wireless base station j₂. Similarly, a UE device 110 corresponding to index i₁ will henceforth be referred to as UE device i₁, and a UE device 110 corresponding to index i₂ will henceforth be referred to as UE device i₂. According to inequality (11), use of wireless base station j₁, instead use of wireless base station j₂, benefits the UE device i₁ more than it benefits LIE device i₂. In particular, using wireless base station j₁ in place of wireless base station j₂ increases a channel estimate for UE device i₁ more than it increases a channel estimate for UE device i₂. Consequently, it is more efficient to use wireless base station j₁ to serve UE device i₁ than it is to use wireless base station jᵢ to serve UE device 110 i₂. Therefore, according to comparative advantage, one of fᵢ_{₁}_{,j}_{₂} and fᵢ_{₂}_{,j}_{₂} must be zero when objective function g(x) is optimized.

Referring again to ordered list 1300 of FIG. 13, the principle discussed above with respect to inequality (11) can be extended to determine boundary index value Ifor ordered list 1300. In particular, for any 1≤i₁<i₂≤N, it must be that either fᵢ_{₁}_{,2}=0 or fᵢ_{₂}_{,1}=0 according to comparative advantage. Therefore, there must exist a boundary index value Ifor ordered list 1300 where the following two mathematical expressions hold:

$${f}_{i , 1} > 0 , {f}_{i , 2} = 0 for 0 < q ( i ) < I \qquad ( 12 )$$

$${f}_{i , 1} = 0 , {f}_{i , 2} > 0 for I < q ( ( i ) < N + 1 \qquad ( 13 )$$

According to mathematical expressions (12) and (13), a wireless base station j₁ should be allocated communication resources for UE devices 110 corresponding to comparative advantage ratios

$${r}_{i}^{( {j}_{1} , {j}_{2} )}$$

with indexes q ranging from 1 to I−1 if ratios are in descending order, and possibly with index q=I, while wireless base station j₂ should be allocated communication resources for UE devices 110 corresponding to comparative advantage ratios

$${r}_{i}^{( {j}_{1} , {j}_{2} )}$$

with indexes q ranging from I+1 to N, and possibly with index q=I Stated differently, according to comparative advantage, UE devices 110 corresponding to comparative advantage ratios

$${r}_{i}^{( {j}_{1} , {j}_{2} )}$$

with values of index q of less than I should be served solely by wireless base station j₁, UE devices 110 corresponding to comparative advantage ratios

$${r}_{i}^{( {j}_{1} , {j}_{2} )}$$

with values of index q greater than I should be served solely by wireless base station j₂, and a UE device corresponding to comparative advantage ratios

$${r}_{i}^{( {j}_{1} , {j}_{2} )}$$

with value of index q equal to I may be served solely by wireless base station j₁, solely by wireless base station j₂, or by a combination of wireless base stations j₁ and j₂.

In view of ordered list 1300 ordering comparative advantage ratios

$${r}_{i}^{( {j}_{1} , {j}_{2} )}$$

in descending order, simplification system 400 may determine boundary index value I for ordered list 1300 by determining at what index q of ordered list 1300 an optimal resource allocation switches from allocating resources to wireless base station j₁ to allocating resources to wireless base station j₂, when optimizing an objective function characterizing cellular wireless communication network 200, e.g., when minimizing objective function g(x). By way of example and not limitation, in certain embodiments, processing subsystem 402 executes boundary determination instructions 414 to determine I for ordered list 1300 as follows.

First, assuming equation (1) and mathematical expressions (12) and (13) hold, resources allocations f_{1,1} and f_{1,2} are constrained according to (14) and (15) as follows:

$${f}_{I , 1} ∈ [ 0 , 1 ] \qquad ( 14 )$$

$${f}_{I , 2} ∈ [ 0 , 1 ] \qquad ( 15 )$$

Mathematical expressions (14) and (15) collectively state that the UE device 110 with an index value q corresponding to boundary index value I could be (a) served solely by wireless base station 112(1), (b) served solely by wireless base station 112(2), or (c) served by a combination of wireless base stations 112(1) and 112(2). Accordingly, simplification system 400 computes SINR xᵢ for all values of f_{I,1} and f_{I,2} as constrained by mathematical expressions (12), (13), (14), and (15) above, using equation (7) above. For example, simplification system 400 may discretize the intervals [0,1] of mathematical expressions (14) and (15) into a series of points {0, 0.01, 0.02, . . . , 0.99, 1} and compute SINR xᵢ at each of these points, subject to the constraints of mathematical expressions (12) and (13). Simplification system 400 next evaluates objective function g(x) for each of the computed SINR values xᵢ using equation (8) above, and simplification system 400 records a value of objective function g_{I}^{*} as defined by equation (16) below.

$${g}_{I}^{*} = {min}_{{{\sum }_{q ( i ) \leq I} {f}_{i , 1} = 1}_{{\sum }_{q ( i ) \geq I} {f}_{i , 2} = 1}} g ( x ) \qquad ( 16 )$$

Simplification system 400 subsequently determines an optimal boundary index value I^{*} using equation (17) below by evaluating

$${g}_{I}^{*}$$

for each possible value of index q. After determining optimal boundary index value I^{*} using equation (17), simplification system 400 sets boundary index value I to determined optimal value.

$${I}^{*} = arg {min}_{I ∈ \{ 1 , ⋯ , N \}} {g}_{I}^{*} \qquad ( 17 )$$

It is understood that the procedure for determining boundary index I discussed above could be adapted to an ordered list which lists comparative advantage ratios

$${r}_{i}^{( {j}_{1} , {j}_{2} )}$$

in ascending order, such as by modifying mathematical expression (12) and (13) to account for comparative advantage ratios

$${r}_{i}^{( {j}_{1} , {j}_{2} )}$$

of the ordered list being listed in ascending order instead of in descending order.

Referring again to FIG. 4, processing subsystem 402 executes matrix modification instructions 416 to generate simplified resource allocation matrix 120 from full resource allocation matrix 118. Specifically, in the case where each of Nand M is two, simplification system 400 is configured to modify full resource allocation matrix 118 to obtain simplified resource allocation matrix 120 by either (a) setting to zero a resource allocation to wireless base station 112(2) that corresponds to a comparative advantage ratio

$${r}_{i}^{( {j}_{1} , {j}_{2} )}$$

of an ordered list 420 with an index value that is equal to one or (b) setting to zero a resource allocation to wireless base station 112(1) that corresponds to a comparative advantage ratio

$${r}_{i}^{( {j}_{1} , {j}_{2} )}$$

of the ordered list 420 with an index value that is equal to two.

For example, assume that (a) full resource allocation matrix 118 for cellular wireless communication network 300 is full resource allocation matrix 700 of FIG. 7 and (b) simplification system 400 forms ordered list 1100 for cellular wireless communication network 300. In this example, comparative advantage ratio

$${r}_{1}^{( 1 , 2 )}$$

of ordered list 1100 has an index q value of one, and comparative advantage ratio

$${r}_{2}^{( 1 , 2 )}$$

of ordered list 1100 has an index q value of two, as illustrated in FIG. 11. Therefore, simplification system 400 would generate a either (a) a simplified resource allocation matrix 1500 (FIG. 15) from full resource allocation matrix 700 by setting to zero a resource allocation to wireless base station 112(2) that corresponds to a comparative advantage ratio

$${r}_{1}^{( 1 , 2 )}$$

of ordered list 1100, i.e., by setting f_{2,1} to zero, or (b) a simplified resource allocation matrix 1600 (FIG. 16) by setting to zero a resource allocation to wireless base station 112(1) that corresponds to a comparative advantage ratio

$${r}_{2}^{( 1 , 2 )}$$

of ordered list 1100, i.e., by setting f_{1,2} to zero. According to equation (1) above, the resource allocations in any given column of a resource allocation matrix must sum to one. Therefore, simplified resource allocation matrices 1500 and 1600 could alternately be expressed as a simplified resource allocation matrix 1700 (FIG. 17) and simplified resource allocation matrix 1800 (FIG. 18), respectively. Simplified resource allocation matrices 1500, 1600, 1700, and 1800 are each an embodiment of simplified resource allocation matrix 120 of FIG. 4.

As another example, assume that (a) full resource allocation matrix 118 for cellular wireless communication network 300 is full resource allocation matrix 700 of FIG. 7 and (b) simplification system 400 forms ordered list 1200 for cellular wireless communication network 300. In this example, comparative advantage ratio

$${r}_{2}^{( 1 , 2 )}$$

of ordered list 1200 has an index q value of one, and comparative advantage ratio

$${r}_{1}^{( 1 , 2 )}$$

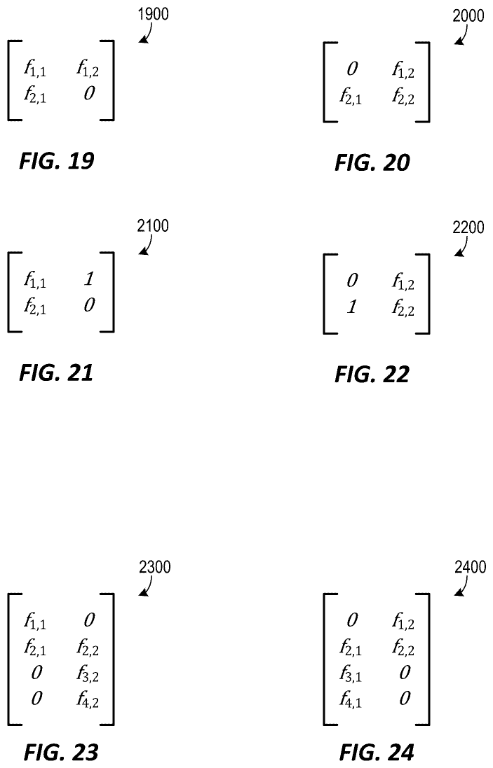

of ordered list 1100 has an index q value of two, as illustrated in FIG. 12. Therefore, simplification system 400 would generate a either (a) a simplified resource allocation matrix 1900 (FIG. 19) from full resource allocation matrix 700 by setting to zero a resource allocation to wireless base station 112(2) that corresponds to a comparative advantage ratio

$${r}_{2}^{( 1 , 2 )}$$

of ordered list 1200, i.e., by setting f_{2,2} to zero, or (b) a simplified resource allocation matrix 2000 (FIG. 20) by setting to zero a resource allocation to wireless base station 112(1) that corresponds to a comparative advantage ratio

$${r}_{1}^{( 1 , 2 )}$$

of ordered list 1200, i.e., by setting f_{1,1} to zero. According to equation (1) above, the resource allocations in any given column of a resource allocation matrix must sum to one. Therefore, simplified resource allocation matrices 1900 and 2000 could alternately be expressed simplified resource allocation matrix 2100 (FIG. 21) and simplified resource allocation matrix 2200 (FIG. 22), respectively. Simplified resource allocation matrices 1900, 2000, 2100, and 2200 are each an embodiment of simplified resource allocation matrix 120 of FIG. 4

It should be noted that each of simplified resource allocation matrices 1700, 1800, 2100, and 2200 has one degree of freedom, while full resource allocation matrix 700 has two degrees of freedom. As such, modifying full resource allocation matrix 700 to obtain simplified resource allocation matrix 1700, 1800, 2100, or 2200 significantly reduces combinations of non-zero resource allocations f_{i,j} that need to be considered by optimization system 104 when determining optimum allocation 116, thereby reducing processing requirements of optimization system 104.

In certain alternate embodiments of simplification system 400 where each of M and N is equal to two and simplification system 400 determines relative values of two comparative advantage ratios

$${r}_{i}^{( {j}_{1} , {j}_{2} )} ,$$

processing subsystem 402 executes matrix modification instructions 416 to generate simplified resource allocation matrix 120 from full resource allocation matrix 118 based on relative values of the two comparative advantage ratios

$${r}_{i}^{( {j}_{1} , {j}_{2} )} .$$

For instance, assume again that (a) full resource allocation matrix 118 for cellular wireless communication network 300 is full resource allocation matrix 700 of FIG. 7, (b) simplification system 400 generates the example comparative advantage ratios

$${r}_{i}^{( {j}_{1} , {j}_{2} )}$$

for cellular wireless communication network 300 that are illustrated in FIG. 8, and (c) the comparative advantage ratios

$${r}_{i}^{( {j}_{1} , {j}_{2} )}$$

of FIG. 8 have relative values as expressed by inequality (2) above. In this case, simplification system 400 may, for example, determine that comparative advantage ratio

$${r}_{1}^{( 1 , 2 )}$$

has a greater value than comparative advantage ratio

$${r}_{2}^{( 1 , 2 )} ,$$

or stated differently, that comparative advantage ratio r₂^{(1,2)} has a lesser value than comparative advantage ratio

$${r}_{1}^{( 1 , 2 )} .$$

In response to the value of comparative advantage ratio

$${r}_{1}^{( 1 , 2 )}$$

being greater than the value of comparative advantage ratio

$${r}_{2}^{( 1 , 2 )} ,$$

simplification system 400 may (a) set f_{1,2} to zero, e.g., to obtain simplified resource allocation matrix 1600 of FIG. 16 or (b) set f_{2,1} to zero, e.g., to obtain simplified resource allocation matrix 1500 of FIG. 15.

Alternately, assume that inequality (2) above does not hold. In this case, simplification system 400 may, for example, determine that comparative advantage ratio

$${r}_{2}^{( 1 , 2 )}$$

has a greater value than comparative advantage ratio

$${r}_{1}^{( 1 , 2 )} ,$$

or stated differently, that comparative advantage ratio

$${r}_{1}^{( 1 , 2 )}$$

has a lesser value than comparative advantage ratio

$${r}_{2}^{( 1 , 2 )} .$$

In response to the value of comparative advantage ratio

$${r}_{2}^{( 1 , 2 )}$$

being greater than the value of comparative advantage ratio

$${r}_{1}^{( 1 , 2 )} ,$$

simplification system 400 may (a) set f_{2,2} to zero, e.g., to obtain simplified resource allocation matrix 1900 of FIG. 19 or (b) set f_{1,1} to zero, e.g., to obtain simplified resource allocation matrix 2000 of FIG. 20.

In the case where Mis equal to two and Nis three or greater, simplification system 400 is configured to modify full resource allocation matrix 118 to obtain simplified resource allocation matrix 120 by (a) setting to zero each resource allocation to wireless base station 112(2) that corresponds to a comparative advantage ratio

$${r}_{i}^{( {j}_{1} , {j}_{2} )}$$

of an ordered list 420 with an index q value that is less than I and (b) setting to zero each resource allocation to wireless base station 112(1) that corresponds to a comparative advantage ratio

$${r}_{i}^{( {j}_{1} , {j}_{2} )}$$

of the ordered list 420 with an index q value that is greater than I.

For example, consider cellular wireless communication network 200 of FIG. 2 and assume that (i) full resource allocation matrix 118 of cellular wireless communication network 200 is full resource allocation matrix 600 of FIG. 6, (ii) ordered list 420 of cellular wireless communication network 200 is ordered list 1300 of FIG. 13, (iii) boundary index value I of ordered list 1300 is equal to two. In this example, simplification system 400 will modify full resource allocation matrix 600 to obtain simplified resource allocation matrix 2300 of FIG. 23 as follows, where simplified resource allocation matrix 2300 is an embodiment of simplified resource allocation matrix 120. In this example, comparative advantage ratio

$${r}_{1}^{( 1 , 2 )}$$

of ordered list 1300 has an index q value that is equal to one, which is less than boundary index value I of two. Therefore, the resource allocation of wireless base station 112(2) corresponding to

$${r}_{1}^{( 1 , 2 )} ,$$

i.e., f_{1,2}, is set to zero. On the other hand, comparative advantage ratio

$${r}_{4}^{( 1 , 2 )}$$

of ordered list 1300 has an index q value that equal to three, which is greater than boundary index value I of two. Therefore, the resource allocation of wireless base station 112(1) corresponding to

$${r}_{4}^{( 1 , 2 )} ,$$

i.e., f_{4,1}, is set to zero. Similarly, comparative advantage ratio

$${r}_{3}^{( 1 , 2 )}$$

of ordered list 1300 has an index q value that equal to four, which is greater than boundary index value I of two. Therefore, the resource allocation of wireless base station 112(1) corresponding to

$${r}_{3}^{( 1 , 2 )} ,$$

i.e., f_{3,1}, is also set to zero. Finally, comparative advantage ratio

$${r}_{2}^{( 1 , 2 )}$$

has index q value equal to boundary index value I of two. Consequently, UE device 110(2), which corresponds to comparative advantage ratio

$${r}_{2}^{( 1 , 2 )} ,$$

could be served by one or both of wireless base station 112(1) and wireless base station 112(2). Therefore, each of the resource allocations to UE device 110(2), i.e., f_{2,1} and f_{2,2}, is left unchanged.

As another example, consider cellular wireless communication network 200 of FIG. 2 and assume that (i) full resource allocation matrix 118 of cellular wireless communication network 200 is full resource allocation matrix 600 of FIG. 6, (ii) ordered list 420 of cellular wireless communication network 200 is ordered list 1400 of FIG. 14, (iii) boundary index value I of ordered list 1400 is equal to three. In this example, simplification system 400 will modify full resource allocation matrix 600 to obtain simplified resource allocation matrix 2400 of FIG. 24 as follows, where simplified resource allocation matrix 2400 is an embodiment of simplified resource allocation matrix 120. In this example, comparative advantage ratio

$${r}_{3}^{( 1 , 2 )}$$

of ordered list 1400 has an index q value that is equal to one, which is less than boundary index value I of three. Therefore, the resource allocation of wireless base station 112(2) corresponding to

$${r}_{3}^{( 1 , 2 )} ,$$

i.e., f_{3,2} is set to zero. Similarly, comparative advantage ratio

$${r}_{4}^{( 1 , 2 )}$$

of ordered list 1400 has an index q value that is equal to two, which is less than boundary index value I of three. Therefore, the resource allocation of wireless base station 112(2) corresponding to

$${r}_{4}^{( 1 , 2 )} ,$$

i.e., f_{4,2}, is set to zero. On the other hand, comparative advantage ratio

$${r}_{1}^{( 1 , 2 )}$$

of ordered list 1400 has an index q value that equal to four, which is greater than boundary index value I of three. Therefore, the resource allocation of wireless base station 112(1) corresponding to

$${r}_{1}^{( 1 , 2 )} ,$$

i.e., f_{1,1}, is set to zero. Finally, comparative advantage ratio

$${r}_{2}^{( 1 , 2 )}$$

has index q value equal to boundary index value I of three. Consequently, UE device 110(2), which corresponds to comparative advantage ratio

$${r}_{2}^{( 1 , 2 )} ,$$

could be served by one or both of wireless base station 112(1) and wireless base station 112(2). Therefore, each of the resource allocations to UE device 110(2), i.e., f_{2,1} and f_{2,2}, is left unchanged.

It should be noted that each simplified resource allocation matrix 2300 and 2400 has one degree of freedom, while full resource allocation matrix 600 has two degrees of freedom. As such, modifying full resource allocation matrix 600 to obtain simplified resource allocation matrix 2300 or 2400 significantly reduces combinations of non-zero resource allocations f_{i,j} that need to be considered by optimization system 104 when determining optimum allocation 116, thereby reducing processing requirements of optimization system 104.

Referring again to FIG. 4, in certain embodiments, processing subsystem 402 executes variable determination instructions 418 to determine quantifying variable α, where a quantifies normalized comparative advantage. Applicant has found that using simplification system 102 to obtain simplified resource allocation matrix 120 from full resource allocation matrix 118 results in close to an optimal solution when a is large, e.g., greater than 0.7. Accordingly, certain embodiments of simplification system 102 condition generation of simplified resource allocation matrix 120 on quantifying variable α being at least a predetermined threshold value, such as at least 0.7. In cases where each of N and M is equal to two, such as in cellular wireless communication network 300 of FIG. 3, certain embodiments of simplification system 400 determine quantifying variable α by solving equation (18) below. It is understood that equation (18) could be modified for applications where one or more of M and N is greater than two.

$$∝ = \vert \frac{{\vert {h}_{1 , 1} {h}_{2 , 2} \vert}^{2} - {\vert {h}_{1 , 2} {h}_{2 , 1} \vert}^{2}}{{\vert {h}_{1 , 1} {h}_{2 , 2} \vert}^{2} + {\vert {h}_{1 , 2} {h}_{2 , 1} \vert}^{2}} \vert \qquad ( 18 )$$

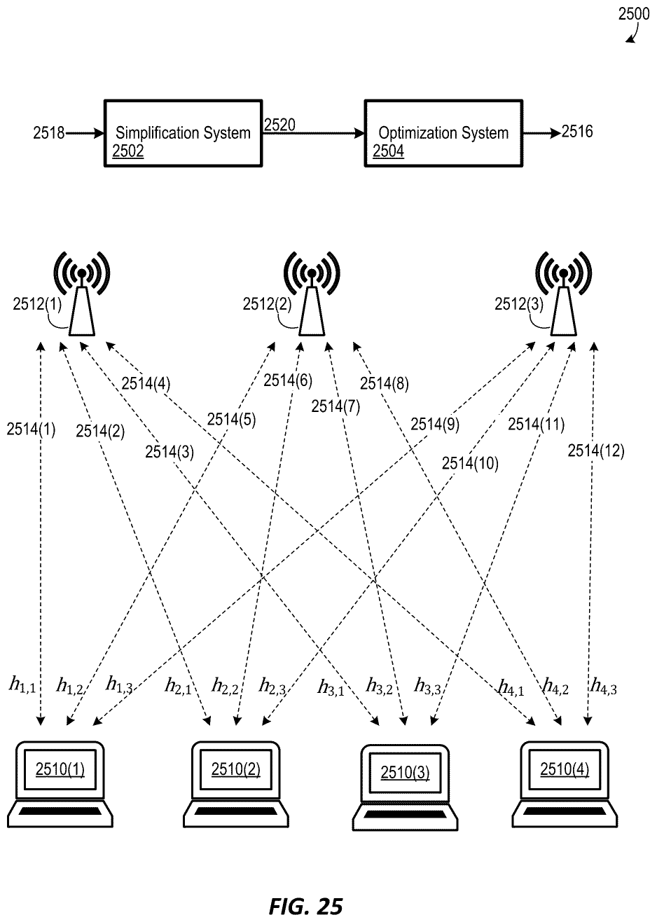

Referring again to FIG. 1, simplification system 102 could be adapted for use with communication networks other than a cellular wireless communication network. For example, FIG. 25 is a schematic diagram of a Wi-Fi wireless communication network 2500 including a simplification system 2502, an optimization system 2504, a plurality of clients in the form of user stations 2510, and a plurality of wireless serving devices in the form of wireless access points (APs) 2512. Wi-Fi wireless communication network 2500 operates according to an IEEE 802.11 standard. Although user stations 2510 are depicted as being computers, user stations 2510 could take other forms. For example, one or more user stations 2510 could be a mobile phone, a set-top device, a data storage device, an IoT device, an entertainment device, a computer networking device, a smartwatch, a wearable device with wireless capability, a medical device, a security device, a monitoring device, and a wireless access device. FIG. 25 illustrates wireless communication channels 2514 which are analogous to communication channels 114 of FIG. 1. Wi-Fi wireless communication network 2500 is configured to generate a respective channel estimate h_{i,j} for each wireless communication channel 2514, as depicted in FIG. 25, where (a) i is an index representing a user station 2510 of the wireless communication channel 2514 and (b) j is an index representing a wireless access point 2512 of the wireless communication channel 2514.

Simplification system 2502 is another embodiment of new systems for simplification of resource allocation in a communication network, and simplification system 2502 is configured to apply comparative advantage to channel estimates h_{i,j} to reduce dimensions of a search space that must be considered by optimization system 2504 when optimizing system 2504 determines an optimum allocation 2516 of communication resources in Wi-Fi wireless communication network 2500. For example, in certain embodiments, simplification system 2502 is configured to use comparative advantage based on channel estimates h_{i,j} to reduce a full resource allocation matrix 2518 to a simplified resource allocation matrix 2520, where full resource allocation matrix 2518 represents all feasible allocations of a given communication resource to wireless access points 2512 and simplified resource allocation matrix 2520 is full resource allocation matrix 2518 modified so that some feasible resource allocations are replaced with zeros. Examples of communication resources allocated by full resource allocation matrix 2518 and simplified resource allocation matrix 2520 include one or more of (a) transmission power allocated to each wireless access point 2512 for each user station 2510, (b) wireless spectrum allocated to each wireless access point 2512 for each user station 2510, and (c) transmission time allocated to each wireless access point 2512 for each user station 2510. In some embodiments, simplification system 2502 is configured to generate simplified resource allocation matrix 2520 from full resource allocation matrix 2518 using a method similar to that discussed above with respect to simplification system 400 of FIG. 4, such as by adapting the method to (a) replace UE devices 110 with user stations 2510 and (b) replace wireless base stations 112 with wireless access points 2512. Additionally, in certain embodiments, simplification system 2502 is embodied in a manner similar to that of simplification system 400.

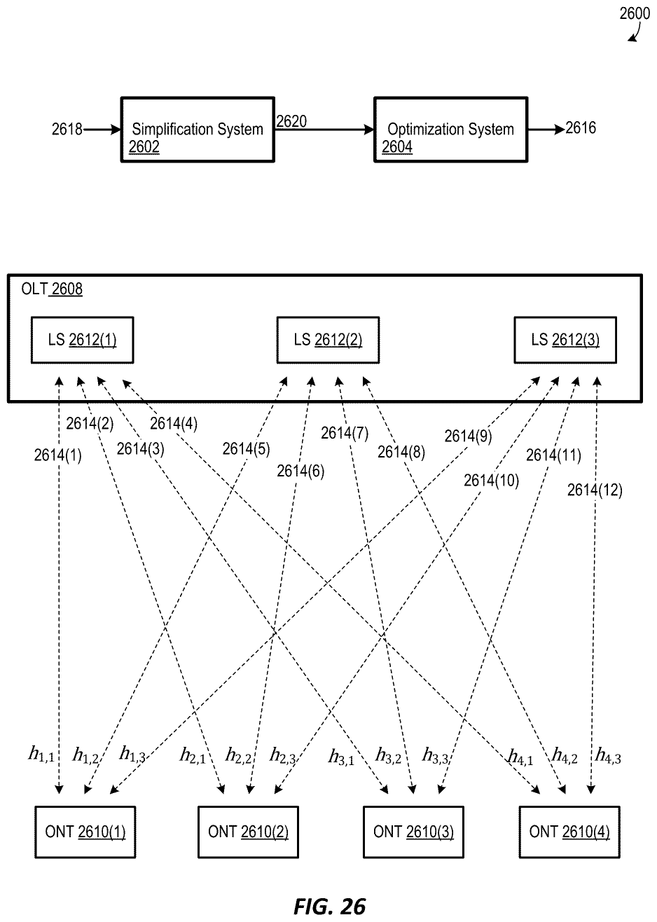

FIG. 26 is a schematic diagram of an optical communication network 2600 including a simplification system 2602, an optimization system 2604, a plurality of clients in the form of optical network terminations (ONTs) 2610, and an optical line terminal (OLT) 2608. In some alternate embodiments, one or more ONT 2610 is replaced with an optical network unit (ONU) or an analogous device. OLT 2608 includes a plurality of serving devices in the form of light sources (LSs) 2612. In some embodiments, each light source 2612 includes a respective laser (not shown) and one or more respective modulators (not shown). In some other embodiments, each light source 2612 includes a respective directly modulated laser (not shown). In some additional embodiments, each light source 2612 includes one or more respective modulators where all modulators of OLT 2608 are supplied by a common laser. In some embodiments, optical communication network 2600 operates according to one or more of a passive optical network (PON) communication protocol, e.g., an Ethernet PON (EPON) communication protocol, a gigabit (GPON) communication protocol, an XG-PON communication protocol, an XGS-PON communication protocol, an NG-PON2 communication protocol, or a coherent PON (CPON) communication protocol, etc. Each light source 2612 can communicate with each ONT 2610 such as via one or more optical cables (not shown) and splitters (not shown) or via free space optical communication. As such, optical communication network 2600 could be either a wireline optical communication network (e.g., a PON wireline network) or a free space wireless optical communication network. FIG. 26 illustrates optical communication channels 2614 which are analogous to wireless communication channels 114 of FIG. 1. Optical communication network 2600 is configured to generate a respective channel estimate h_{i,j} for each optical communication channel 2614, as depicted in FIG. 26, where (a) i is an index representing an ONT 2610 of the optical communication channel 2614 and (b) j is an index representing a light source 2612 of the optical communication channel 2614.

Simplification system 2602 is another embodiment of new systems for simplification of resource allocation in a communication network, and simplification system 2602 is configured to apply comparative advantage to channel estimates h_{i,j} to reduce dimensions of a search space that must be considered by optimization system 2604 when optimizing system 2604 determines an optimum allocation 2616 of communication resources in optical communication network 2600. For example, in certain embodiments, simplification system 2602 is configured to use comparative advantage based on channel estimates h_{i,j} to reduce a full resource allocation matrix 2618 to a simplified resource allocation matrix 2620, where full resource allocation matrix 2618 represents all feasible allocations of a given communication resource to light sources 2612 and simplified resource allocation matrix 2620 is full resource allocation matrix 2618 modified so that some feasible resource allocations are replaced with zeros. Examples of communication resources allocated by full resource allocation matrix 2618 and simplified resource allocation matrix 2620 include one or more of (a) transmission power allocated to each light source 2612 for each ONT 2610, (b) optical wavelength allocated to each light source 2612 for each ONT 2610, and (c) transmission time allocated to each light source 2612 for each ONT 2610. In some embodiments, simplification system 2602 is configured to generate simplified resource allocation matrix 2620 from full resource allocation matrix 2618 using a method similar to that discussed above with respect to simplification system 400 of FIG. 4, such as by adapting the method to (a) replace UE devices 110 with ONTs 2610 and (b) replace wireless base stations 112 with light sources 2612. Additionally, in certain embodiments, simplification system 2602 is embodied in a manner similar to that of simplification system 400.

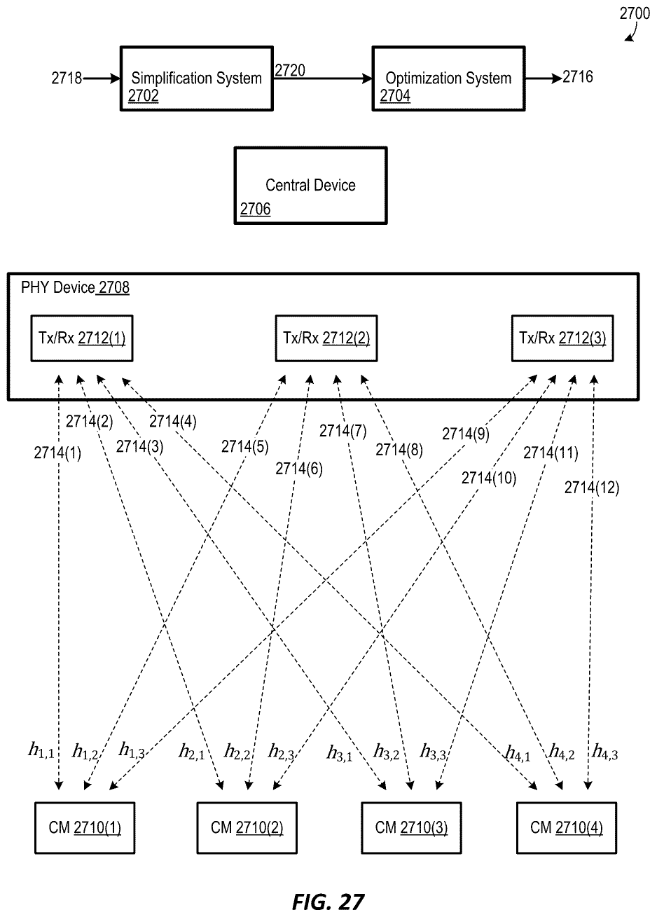

FIG. 27 is a schematic diagram of a cable wireline communication network 2700 including a simplification system 2702, an optimization system 2704, a central device 2706 (e.g., a cable modem termination system or a converged cable access platform), a plurality of clients in the form of cable modems (CMs) 2710, and a Physical (PHY) device 2708. PHY device 2708 is, for example, a fiber node or a remote PHY device (RPD) that is communicatively coupled to central device 2706 via one or more cables (not shown). In certain alternate embodiments, though, PHY device 2708 is integrated with central device 2706. PHY device 2708 includes a plurality of serving devices in the form of transceivers (Tx/Rxs) 2712, where each transceiver 2712 is configured to convert signals between (a) an electrical or optical domain and (b) a radio frequency (RF) domain. In some embodiments, cable wireline communication network 2700 operates according to a DOCSIS communication protocol. Each transceiver 2712 can communicate with each cable modem 2710 via a cable network (not shown for illustrative clarity), such as a cable network including one or more coaxial cables, amplifiers, taps, power inserters, etc. FIG. 27 illustrates cable communication channels 2714 which are analogous to wireless communication channels 114 of FIG. 1. Cable wireline communication network 2700 is configured to generate a respective channel estimate h_{i,j} for each cable communication channel 2714, as depicted in FIG. 27, where (a) i is an index representing a cable modem 2710 of the cable communication channel 2714 and (b) j is an index representing a transceiver 2712 of the cable communication channel 2714.

Simplification system 2702 is another embodiment of new systems for simplification of resource allocation in a communication network, and simplification system 2702 is configured to apply comparative advantage to channel estimates h_{i,j} to reduce dimensions of a search space that must be considered by optimization system 2704 when optimization system 2704 determines an optimum allocation 2716 of communication resources in cable wireline communication network 2700. For example, in certain embodiments, simplification system 2702 is configured to use comparative advantage based on channel estimates h_{i,j} to reduce a full resource allocation matrix 2718 to a simplified resource allocation matrix 2720, where full resource allocation matrix 2718 represents all feasible allocations of a given communication resource to transceivers 2712 and simplified resource allocation matrix 2720 is full resource allocation matrix 2718 modified so that some feasible resource allocations are replaced with zeros. Examples of communication resources allocated by full resource allocation matrix 2718 and simplified resource allocation matrix 2720 include one or more of (a) transmission power allocated to each transceiver 2712 for each cable modem 2710, (b) frequency range or channel(s) allocated to each transceiver 2712 for each cable modem 2710, and (c) transmission time allocated to each transceiver 2712 for each cable modem 2710. In some embodiments, simplification system 2702 is configured to generate simplified resource allocation matrix 2720 from full resource allocation matrix 2718 using a method similar to that discussed above with respect to simplification system 400 of FIG. 4, such as by adapting the method to (a) replace UE devices 110 with cable modems 2710 and (b) replace wireless base stations 112 with transceivers 2712. Additionally, in certain embodiments, simplification system 2702 is embodied in a manner similar to that of simplification system 400.

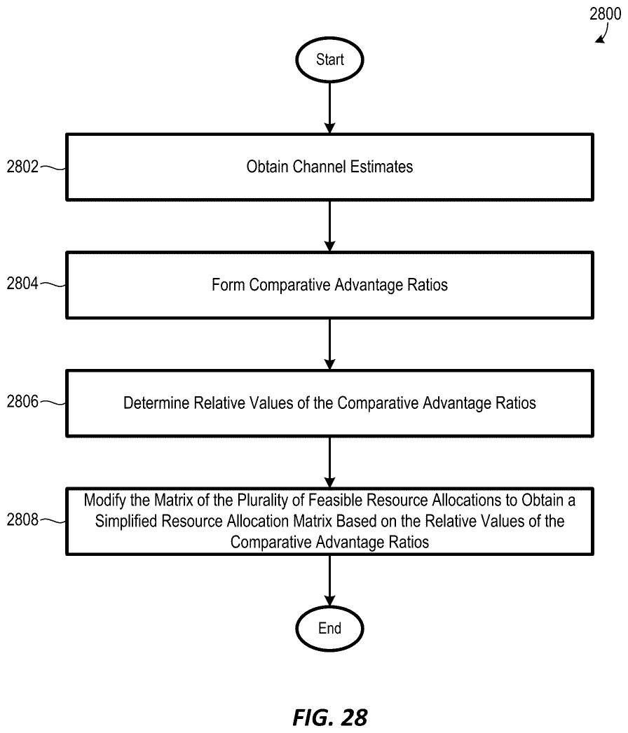

Discussed below with respect to FIGS. 28-30 are three examples of operation of the new systems for simplification of resource allocation in a communication network, although it is understood that the new systems are not limited to operating according to the examples of FIGS. 28-30. Additionally, although the examples below are primarily discussed with respect to cellular wireless communication networks, the examples below could also be adopted to other communication networks, such as Wi-Fi wireless communication network 2500 of FIG. 25, optical communication network 2600 of FIG. 26, and cable wireline communication network 2700 of FIG. 27.

FIG. 28 is a flow chart of a method 2800 for simplification of resource allocation in a wireless communication network including a first client, a second client, a first wireless serving device, and a second wireless serving device. In a block 2802 of method 2800, a plurality of channel estimates are obtained from the wireless communication network, where each channel estimate is associated with a respective resource allocation of a matrix of a plurality of feasible resource allocations. In one example of block 2802, processing subsystem 402 executes data acquisition instructions 408 to obtain channel estimates h_{i,j} from cellular wireless communication network 300, where each channel estimate h_{i,j} is associated with a respective resource allocation f_{i,j} of full resource allocation matrix 700.

Method 2800 proceeds from block 2802 to a block 2804 where respective comparative advantage ratios are formed for each of the first client and the second client. The respective comparative advantage ratio for each client is an absolute value of a ratio of (1) a channel estimate of the plurality of channel estimates representing response of a communication channel between the client and the first wireless serving device and (2) a channel estimate of the plurality of channel estimates representing response of a communication channel between the client and the second wireless serving device. In one example of block 2804, processing subsystem 402 executes comparative advantage ratio instructions 410 to form the example comparative advantage ratios

$${r}_{i}^{( {j}_{1} , {j}_{2} )}$$

for cellular wireless communication network 300 that are illustrated in FIG. 8. Method 2800 proceeds from block 2804 to a block 2806 where relative values of the respective comparative advantage ratios for the first and second clients are determined. In one example of block 2806, processing subsystem 402 executes ordering instructions 412 to determine that comparative advantage ratio

$${r}_{1}^{( 1 , 2 )}$$

has a greater value than comparative advantage ratio

$${r}_{2}^{( 1 , 2 )} ,$$

or to determine that comparative advantage ratio

$${r}_{2}^{( 1 , 2 )}$$

has a lesser value than comparative advantage ratio

$${r}_{1}^{( 1 , 2 )} .$$

Method 2800 proceeds from block 2806 to a block 2808 where, in response to a value of the respective comparative advantage ratio for the first client being greater than a value of the respective comparative advantage ratio for the second client, the matrix of the plurality of feasible resource allocations is modified to obtain a simplified resource allocation matrix at least partially by either (1) setting to zero a resource allocation to the second wireless serving device corresponding to the respective comparative advantage ratio for the first client or (2) setting to zero a resource allocation to the first wireless serving device corresponding to the respective comparative advantage ratio for the second client. In one example of block 2808, processing subsystem 402 executes matrix modification instructions 416 to either (a) set f_{1,2} to zero or (b) set f_{2,1} to zero, in response to a value of comparative advantage ratio

$${r}_{1}^{( 1 , 2 )}$$

being a greater value than a value of comparative advantage ratio

$${r}_{2}^{( 1 , 2 )} .$$

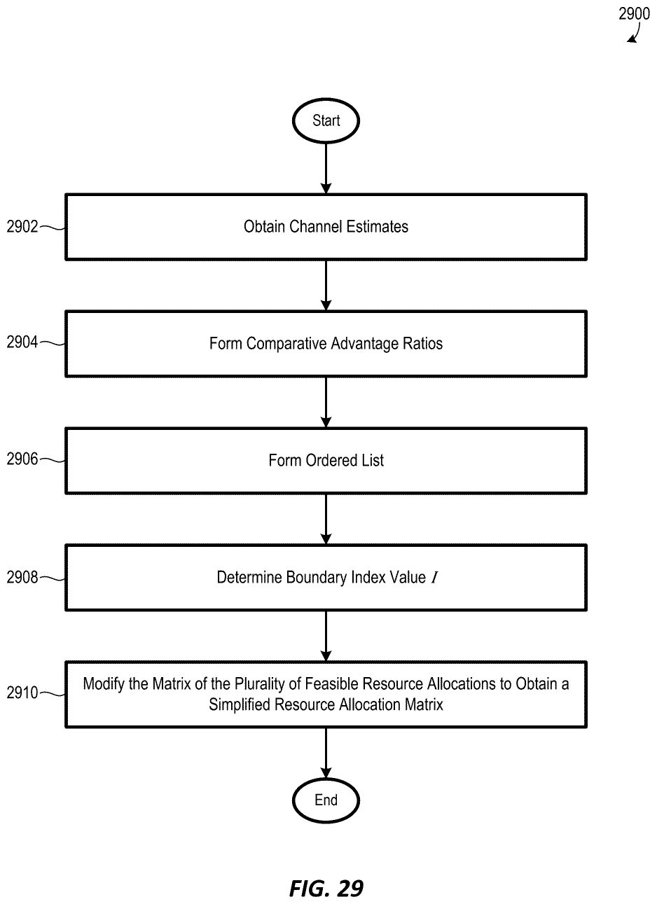

FIG. 29 is a flow chart of a method 2900 for simplification of resource allocation in a wireless communication network including a plurality of clients, a first wireless serving device, and a second wireless serving device. In a block 2902 of method 2900, a plurality of channel estimates are obtained from the wireless communication network, where each channel estimate is associated with a respective resource allocation of a matrix of a plurality of feasible resource allocations. In one example of block 2902, processing subsystem 402 executes data acquisition instructions 408 to obtain channel estimates h_{i,j} from cellular wireless communication network 200, where each channel estimate h_{i,j} is associated with a respective resource allocation f_{i,j} of full resource allocation matrix 600.

Method 2900 proceeds from block 2902 to a block 2904 where respective comparative advantage ratios are formed for each client. The respective comparative advantage ratio for each client is an absolute value of a ratio of (1) a channel estimate of the plurality of channel estimates representing response of a communication channel between the client and the first wireless serving device and (2) a channel estimate of the plurality of channel estimates representing response of a communication channel between the client and the second wireless serving device. In one example of block 2904, processing subsystem 402 executes comparative advantage ratio instructions 410 to form the example comparative advantage ratios

$${r}_{i}^{( {j}_{1} , {j}_{2} )}$$

for cellular wireless communication network 200 that are illustrated in FIG. 9.

Method 2900 proceeds from block 2904 to a block 2906 where an ordered list of comparative advantage ratios is formed by ordering the respective comparative advantage ratios of the clients in one of a descending order and an ascending order. Each comparative advantage ratio of the ordered list has a respective index q. In one example of block 2906, processing subsystem 402 executes ordering instructions 412 to form ordered list 1300 from the example comparative advantage ratios

$${r}_{i}^{( {j}_{1} , {j}_{2} )}$$

illustrated in FIG. 9. Method 2900 proceeds from block 2906 to a block 2908 to determine a boundary index value I of the ordered list where an optimal resource allocation switches from allocating communication resources to the first wireless serving device to allocating communication resources to the second wireless serving device, when (a) optimizing an objective function that characterizes the wireless communication network and (b) the objective function, or a negative of the objective function, satisfies the Inada conditions. In one example of block 2908, processing subsystem 402 executes boundary determination instructions 414 to determine a boundary index value I of ordered list 1300 where I=2.

Method 2900 proceeds from block 2908 to a block 2910 where the matrix of the plurality of feasible resource allocations is modified to obtain a simplified resource allocation matrix at least partially by (1) setting to zero each resource allocation to the second wireless serving device corresponding to a comparative advantage ratio of the ordered list with a respective of index q value that is less than boundary index value I and (2) setting to zero each resource allocation to the first wireless serving device corresponding to a comparative advantage ratio of the ordered list with a respective index q value that is greater than boundary index value I In one example of block 2910, processing subsystem 402 executes matrix modification instructions 416 to modify full resource allocation matrix 600 based on ordered list 1300 and a value of boundary index value I equal to two to obtain simplified resource allocation matrix 2300 of FIG. 23.

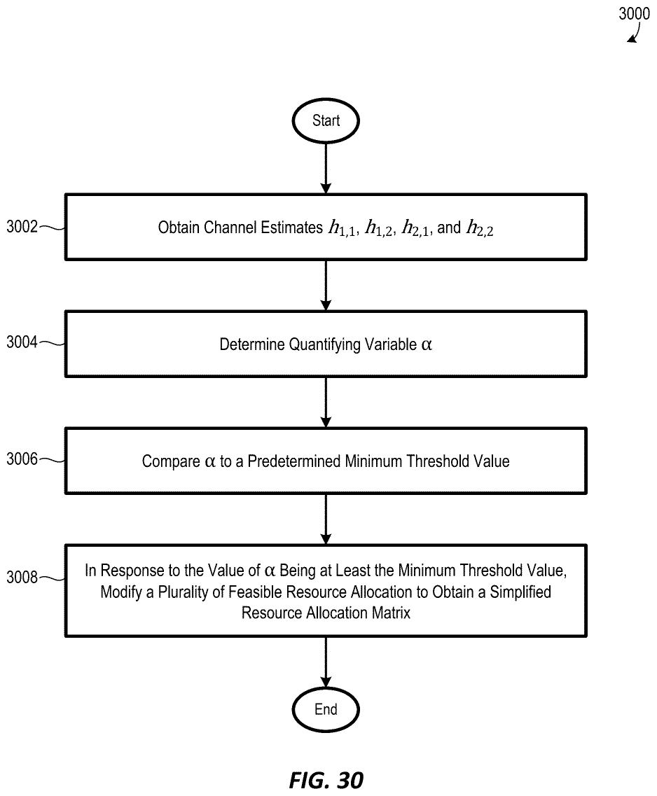

FIG. 30 is a flow chart of a method 3000 for simplification of resource allocation in a wireless communication network including a first client, a second client, a first wireless serving device, and a second wireless serving device. In a block 3002 of method 3000, channel estimates h_{1,1}, h_{1,2}, h_{2,1}, and h_{2,2} are obtained from the wireless communication network, where (a) h_{1,1} represents response of a communication channel between the first client and the first wireless serving device, (b) h_{1,2} represents response of a communication channel between the first client and the second wireless serving device, (c) h_{2,1} represents response of a communication channel between the second client and the first wireless serving device, and (d) h_{2,2} represents response of a communication channel between the second client and the second wireless serving device. In one example of block 3002, processing subsystem 402 executes data acquisition instructions 408 to obtain channel estimates h_{1,1}, h_{1,2}, h_{2,1}, and h_{2,2} from cellular wireless communication network 300.

Method 3000 proceeds from block 3002 to a block 3004 to determine a quantifying variable α, such as according to equation (18) above. In one example of block 3004, processing subsystem 402 executes variable determination instructions 418 to determine quantifying variable α using equation (18). Method 3000 proceeds from block 3004 to a block 3006 to compare quantifying variable α to a predetermined minimum threshold value. In one example of block 3006, processing subsystem 402 executes instructions (not shown) stored in information store 404 to compare quantifying variable α to a predetermined minimum threshold value of 0.7. Method 3000 proceeds from block 3006 to a block 3008, where, in response to the value of α being at least the minimum threshold value, a matrix of a plurality of feasible resource allocations is modified to obtain a simplified resource allocation matrix. In one example of block 3008, simplification system 400 performs the steps discussed above to obtain (a) the comparative advantage ratios of FIG. 8 from full resource allocation matrix 700, (b) the ordered list of either FIG. 11 or FIG. 12, and (c) the simplified resource allocation matrix of FIG. 15, FIG. 16, FIG. 17, FIG. 18, FIG. 19, FIG. 20, FIG. 21, or FIG. 22.

Referring again to FIGS. 1-3, while simplification system 102 is discussed above as obtaining a simplified resource allocation matrix 120 for all wireless base stations 112 of a given cellular wireless communication network, simplification system 102 could alternately be configured to obtain a simplified resource allocation matrix 120 for only a subset of wireless base stations 112 of a given cellular wireless communication network. Alternately or additionally, simplification system 102 could be configured to obtain respective simplified resource allocation matrices 120 for two or more different groups of wireless base stations 112 in a given cellular wireless communication network, such as by executing one or more of the methods discussed above two or more times. The simplification systems of the other communication networks discussed above could also be alternately configured in a similar manner.

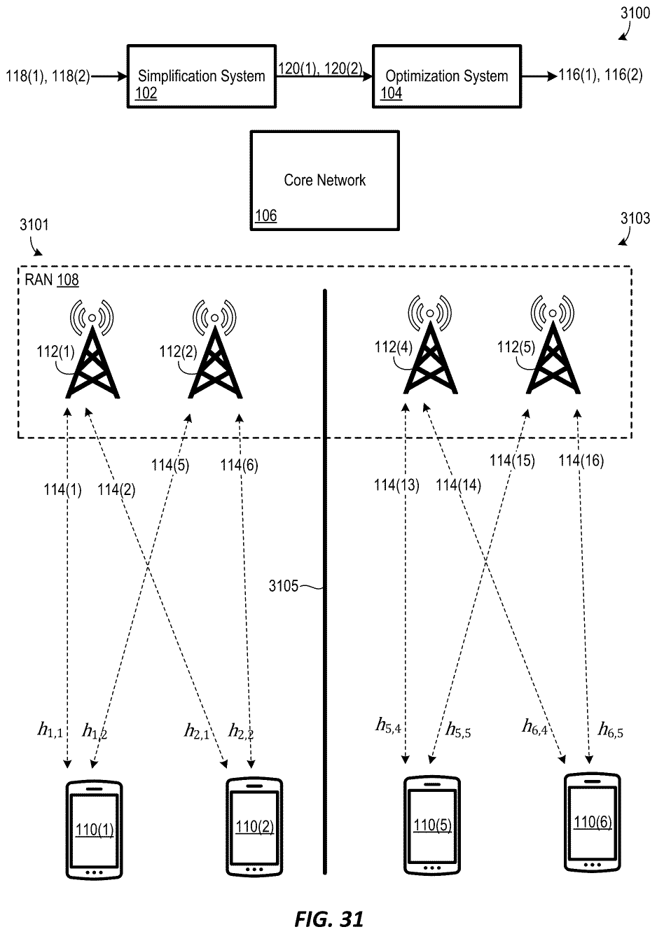

For example, FIG. 31 is a schematic diagram of a cellular wireless communication network 3100, which is an alternate embodiment of cellular wireless communication network 300 (FIG. 3) further including a cellular wireless base station 112(4), a cellular wireless base station 112(5), a UE device 110(5), and a UE device 110(6). Cellular wireless communication network 3100 includes two groups of wireless base stations 112 and UE devices 110. Specifically, a first group 3101 includes wireless base station 112(1), wireless base station 112(2), UE device 110(1), and UE device 110(2). A second group 3103 includes wireless base station 112(4), wireless base station 112(5), LE device 110(5), and UE device 110(6). Group 3101 is allocated resources independently of group 3103, as symbolically shown by a line 3105 separating the two groups, such as due to a desire to operate groups 3101 and 3103 independently, or due to groups 3101 and 3103 being outside of radio frequency range of each other.

Simplification system 102 is configured in cellular wireless communication network 3100 to (a) obtain a simplified resource allocation matrix 120(1) for group 3101 from a full resource allocation matrix 118(1) for group 3101 and (b) obtain a simplified resource allocation matrix 120(2) for group 3103 from a full resource allocation matrix 118(2) for group 3103. For example, simplification system 102 may execute one instance of method 2800 (FIG. 28) for each of group 3101 and group 3103, either in parallel or in series. As another example, simplification system 102 may execute one instance of method 3000 (FIG. 30) for each of group 3101 and group 3103, either in parallel or in series.

### Example Embodiment—NOMA

In non-independent multi-cell multi-user transmission, with NOMA and full-rate CoMP included, the limiting SINR, i.e. the SINR that is used to calculate bit rate, at the i-th UE device 110 can be expressed as by equation (19) as follows:

$${η}_{τ , i} = min \{ \begin{matrix}\frac{{x}_{i}}{{Σ}_{k ∈ {A}_{τ , i}} {Σ}_{1 \leq j \leq M} {\vert {h}_{i , j} \vert}^{2} {p}_{j} {f}_{k , j} + 1} , \\ {min}_{k ∈ {A}_{τ , i}} \frac{{Σ}_{1 \leq j \leq M} {\vert {h}_{k , j} \vert}^{2} {p}_{j} {f}_{i , j}}{{Σ}_{l ∈ {A}_{τ , i}} {Σ}_{1 \leq j \leq M} {\vert {h}_{k , j} \vert}^{2} {p}_{j} {f}_{l , j} + 1}\end{matrix} \} \qquad ( 19 )$$

A_{τ,i} in equation (19) is the set of UE devices 110 that come after the i-th UE device 110 in a SIC decoding order τ, i.e. all UE devices 110 in A_{τ,i} need to decode the i-th UE device 110's signal for SIC. The first term inside the brackets of equation (19) is the SINR at the i-th UE device 110, while the second term inside the brackets of equation (19) is the lowest SINR of the i-th UE device 110's signal across all UE devices 110 that come after the i-th UE device 110 in SIC decoding order τ. Equation (19) includes all downlink scenarios, and the min( ) operations are required even if the SIC decoding order is determined, due to the nature of multi-cell communication.

Objective function g(x) of equation (8) above can be modified to account for NOMA and full-rate CoMP by replacing x with ητ=(η_{τ,1} . . . η_{τ,N}) to yield objective function g(η_{τ}) of equation (20) below.

$$g ( {η}_{τ} ) = {max}_{i} \frac{{w}_{i}}{log ( 1 + {η}_{τ , i} )} \qquad ( 20 )$$

While objective function g(η_{τ}) satisfies the Inada conditions with respect to θ_{τ}, objective function g(η_{τ}) is nonlinear with respect to f Additionally, objective function g(η_{τ}) is subject to SIC order τ which changes its expression with respect to f Therefore, it is not possible to explicitly find coefficients to express a criterion for comparative advantage characterization, let alone provide a closed form solution for finding the coefficients.

If each of M and N is equal to two, possible values of η_{τ,i} are constrained to the six equations below. τ₀ corresponds to no SIC being performed, τ₁ corresponds to SIC being performed with UE device 110(1) having a smaller index than UE device 110(2) such that UE device 110(1) is decoded before UE device 110(2), and τ₂ corresponds to SIC being performed with UE device 110(2) having a smaller index than UE device 110(1) such that UE device 110(2) is decoded before UE device 110(1).

$${η}_{{τ}_{0 ,} 1} = \frac{{\vert {h}_{11} \vert}^{2} {p}_{1} {f}_{11} + {\vert {h}_{12} \vert}^{2} {p}_{2} {f}_{12}}{{\vert {h}_{11} \vert}^{2} {p}_{1} {f}_{21} + {\vert {h}_{12} \vert}^{2} {p}_{2} {f}_{22} + 1} \qquad ( 21 )$$

$${η}_{{τ}_{0 ,} 2} = \frac{{\vert {h}_{21} \vert}^{2} {p}_{1} {f}_{21} + {\vert {h}_{22} \vert}^{2} {p}_{2} {f}_{22}}{{\vert {h}_{21} \vert}^{2} {p}_{1} {f}_{11} + {\vert {h}_{22} \vert}^{2} {p}_{2} {f}_{12} + 1} \qquad ( 22 )$$

$${η}_{{τ}_{1} , 1} = min \{ \begin{matrix}\frac{{\vert {h}_{11} \vert}^{2} {p}_{1} {f}_{11} + {\vert {h}_{12} \vert}^{2} {p}_{2} {f}_{12}}{{\vert {h}_{11} \vert}^{2} {p}_{1} {f}_{21} + {\vert {h}_{12} \vert}^{2} {p}_{2} {f}_{22} + 1} , \\ \frac{{\vert {h}_{21} \vert}^{2} {p}_{1} {f}_{11} + {\vert {h}_{22} \vert}^{2} {p}_{2} {f}_{12}}{{\vert {h}_{21} \vert}^{2} {p}_{1} {f}_{21} + {\vert {h}_{22} \vert}^{2} {p}_{2} {f}_{22} + 1}\end{matrix} \} \qquad ( 23 )$$

$${η}_{{τ}_{1} , 2} = {\vert {h}_{21} \vert}^{2} {p}_{1} {f}_{21} + {\vert {h}_{22} \vert}^{2} {p}_{2} {f}_{22} \qquad ( 24 )$$

$${η}_{{τ}_{2} , 1} = {\vert {h}_{11} \vert}^{2} {p}_{1} {f}_{11} + {\vert {h}_{12} \vert}^{2} {p}_{2} {f}_{12} \qquad ( 25 )$$

$${η}_{{τ}_{2} , 2} = min \{ \begin{matrix}\frac{{\vert {h}_{21} \vert}^{2} {p}_{1} {f}_{21} + {\vert {h}_{22} \vert}^{2} {p}_{2} {f}_{22}}{{\vert {h}_{21} \vert}^{2} {p}_{1} {f}_{11} + {\vert {h}_{22} \vert}^{2} {p}_{2} {f}_{12} + 1} , \\ \frac{{\vert {h}_{11} \vert}^{2} {p}_{1} {f}_{21} + {\vert {h}_{12} \vert}^{2} {p}_{2} {f}_{22}}{{\vert {h}_{11} \vert}^{2} {p}_{1} {f}_{11} + {\vert {h}_{12} \vert}^{2} {p}_{2} {f}_{12} + 1}\end{matrix} \} \qquad ( 26 )$$

An optimum value of τᵢ may be found by executing equation (20) for each possible value of τᵢ, i.e, τ₀, τ₁, and τ₂, as expressed by equations (21)-(26) above, and selecting whichever value of τᵢ results in a minimum value of g(η_{τ}), as expressed by mathematical expression (27) below. While an optimum value of objective function g(η_{τ}) can be determined by applying mathematical expressions (19)-(27) over a full search space, significant processing resources are required to do so.

$$min \{ g ( {η}_{{τ}_{0}} ) , g ( {η}_{{τ}_{1}} ) , g ( {η}_{{τ}_{2}} ) \} \qquad ( 27 )$$

However, Applicant has determined that new systems and methods for simplification of resource allocation in a communication network can instead be used in a NOMA and full-rate CoMP application to reduce processing requirements while still achieving a near optimal solution. For example, FIG. 32 is a schematic diagram of a cellular wireless communication network 3200, which is an alternate embodiment of cellular wireless communication network 300 (FIG. 3) that further includes a decoding order system 3222 to support NOMA and full-rate CoMP. Cellular wireless communication network 3200 includes the features of cellular wireless communication network 300. Additionally, cellular wireless communication network 3200 further includes decoding order system 3222, and cellular wireless communication network 3200 includes an optimization system 3204 in place of optimization system 104. Simplification system 102 determines simplified resource allocation matrix 120 from full resource allocation matrix 118, for example, using a method analogous to that discussed above with respect to cellular wireless communication network 300, thereby significantly reducing the processing requirements of optimization system 3204. Additionally, decoding order system 3222 provides the optimum value of τᵢ to optimization system 3204, and optimization system 3204 determines optimum allocation 116 from simplified resource allocation matrix 120 based on the optimum value of τᵢ.

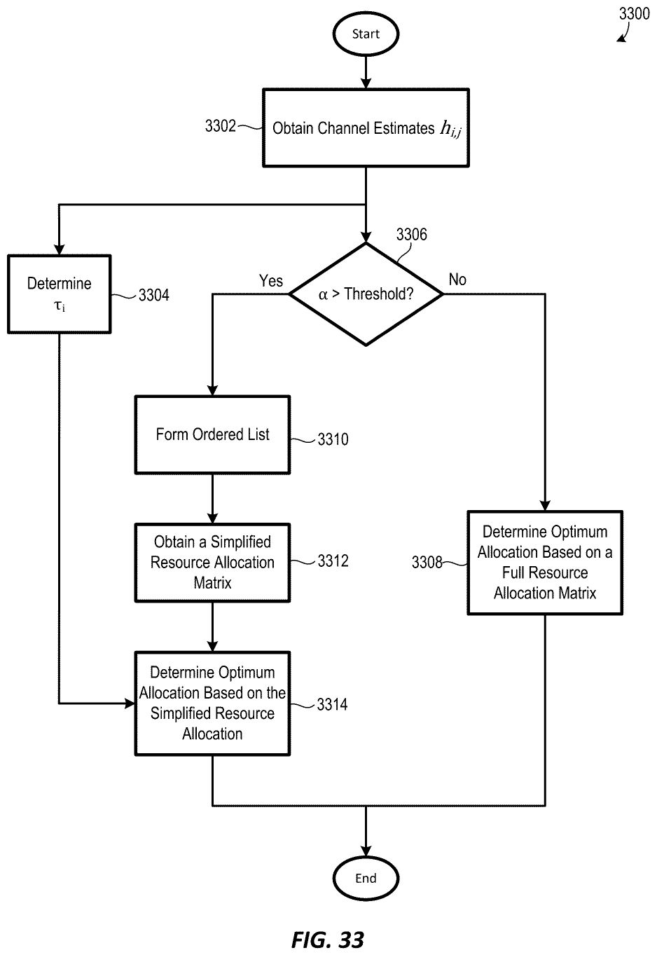

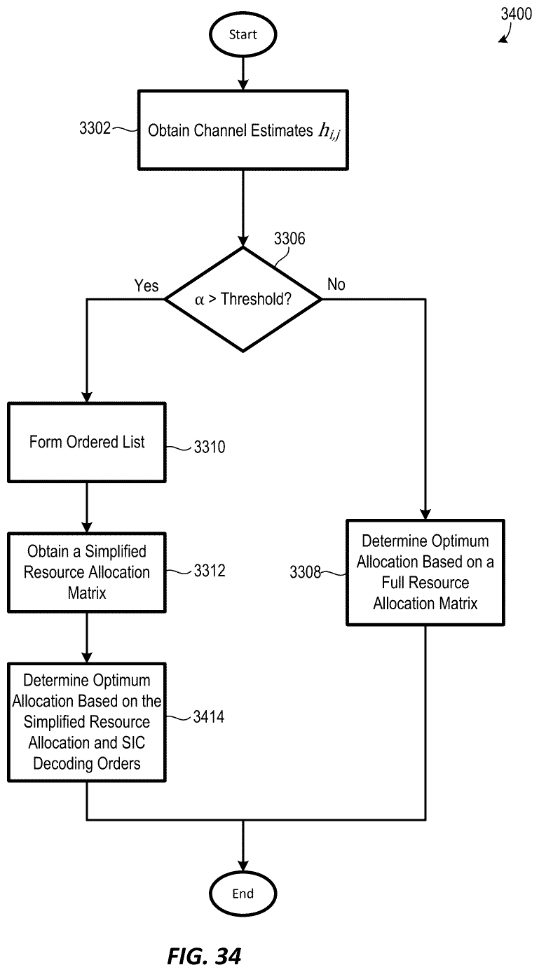

Discussed below with respect to FIGS. 33 and 34 are two examples of operation of cellular wireless communication network 3200. However, it is understood that cellular wireless communication network 3200 is not limited to operating according to these examples.

FIG. 33 is a flow chart of a method 3300 for simplification of resource allocation in a wireless communication network including a first UE device, a second UE device, a first wireless base station, and a second wireless base station. In a block 3302 of method 3300, a plurality of channel estimates are obtained from the wireless communication network, where each channel estimate is associated with a respective resource allocation of a matrix of a plurality of feasible resource allocations. In one example of block 3302, processing subsystem 402 executes data acquisition instructions 408 to obtain channel estimates h_{i,j} from cellular wireless communication network 3200, where each channel estimate h_{i,j} is associated with a respective resource allocation f_{i,j} of full resource allocation matrix 700. Method proceeds from block 3302 to a 3304 where an optimum value of SIC decoding order τᵢ is determined. In one example of block 3304, decoding order system 3222 of cellular wireless communication network 3200 determines an optimum value of SIC decoding order τᵢ and provides it to optimization system 3204 of cellular wireless communication network 3200.

Method 3300 also proceeds from block 3302 to a decision block 3306 where a quantifying variable α is determined and compared to a predetermined threshold value to determine whether the quantifying variable α exceeds the predetermined threshold value. In one example of decision block 3306, processing subsystem 402 executes variable determination instructions 418 to determine quantifying variable α and determine whether it exceeds a predetermined threshold value of 0.7. If the result of decision block 3306 is no, method 3300 proceeds to a block 3308 to determine an optimum allocation of communication resources based on a full resource allocation matrix. In one example of block 3308, optimization system 3204 determines optimum allocation 116 based on full resource allocation matrix 118 instead of based on simplified resource allocation matrix 120.

If the result of decision block 3306 is yes, method 3300 proceeds to a block 3310 to form comparative advantage ratios and to form an ordered list of the comparative advantage ratios. In one example of block 3310, (a) processing subsystem 402 executes comparative advantage ratio instructions 410 to form the comparative advantage ratios

$${r}_{i}^{( {j}_{1} , {j}_{2} )}$$

of FIG. 8 and (b) processing subsystem 402 executes ordering instructions 412 to form an ordered list of the comparative advantage ratios. In one example of block 2610, processing subsystem 402 executes ordering instructions 412 to form ordered list 1100 of FIG. 11 from the example comparative advantage ratios

$${r}_{i}^{( {j}_{1} , {j}_{2} )}$$

illustrated in FIG. 8. Method 3300 proceeds from block 3310 to a block 3312 to obtain a simplified resource allocation matrix. In one example of block 3312, processing subsystem 402 executes matrix modification instructions 416 to modify full resource allocation matrix 700 based on ordered list 1100 to obtain simplified resource allocation matrix 1700 or 1800.

Method 3300 proceeds from block 3312 to 3314 to determine an optimum allocation of communication resources based on the simplified resource allocation matrix obtained in block 3312 and the optimum value of SIC decoding order τᵢ determined in block 3304. In one example of block 3314, optimization system 3204 determines optimum allocation 116 based on (a) simplified resource allocation matrix 120 and (b) the optimum value of SIC decoding order z, from decoding order system 3222.

FIG. 34 is a flow chart of a method 3400 for simplification of resource allocation in a wireless communication network including a first UE device, a second UE device, a first wireless base station, and a second wireless base station. Method 3400 is an alternate embodiment of method 3300 of FIG. 33 where block 3304 is omitted and block 3314 is replaced with a block 3414. In block 3414, an optimum value of SIC decoding order zi is determined while determining an optimum allocation of communication resources based on the simplified resource allocation matrix obtained in block 3312. As such, block 3414 of method 3400 is a combination of blocks 3304 and 3314 of FIG. 33.

### Experimental Results

Applicant conducted Monte Carlo simulations and SDR tests based on mathematical expressions (19)-(27) above and determined that the penalty induced by reducing the search space based on comparative advantage is statistically minimal. Additionally, the simulations showed that a value of quantifying variable α can indicate whether the reduced search space likely includes a global optimum resource allocation value.

In particular, to examine the feasibility of the new methods disclosed herein, Applicant ran Monte Carlo simulations that uniformly and randomly cast two UE devices over a 1000-meter-by-500-meter area (horizontal: 0-1000 meters; vertical: 0-500 meters). Two wireless base stations were located at coordinates of (250, 250) and (750, 250), and the two UE devices could communicate with either, or both, of the wireless base stations at a center frequency of one gigahertz (GHz). The shared channel had a bandwidth of 20 megahertz (MHz), and the transmitted power from each wireless base station was 10 watts (W). The wireless channels in the simulations were slow fading channels, i.e. channel response did not change within one allocation cycle, with a path loss exponent of three.

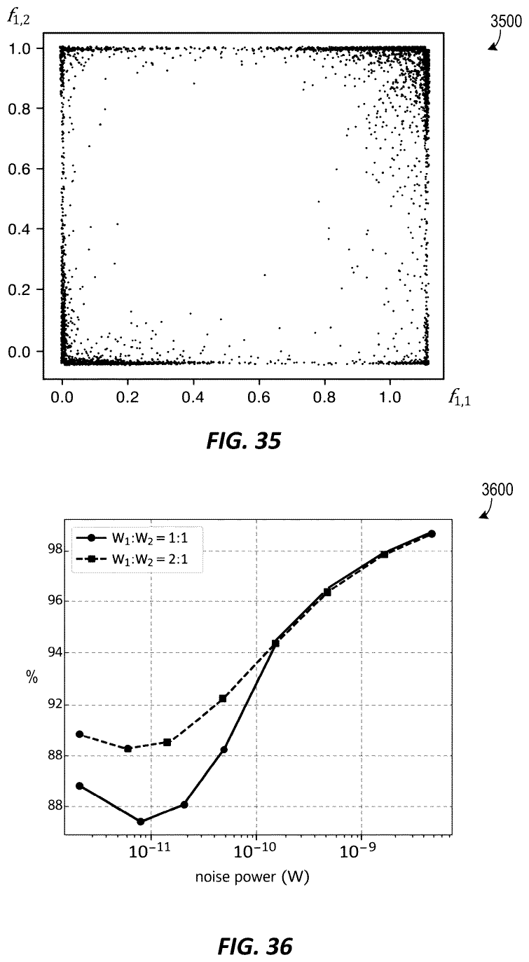

FIG. 35 is a graph 3500 illustrating optimal resource allocations from the Monte Carlo simulations where each instance of an optimal resource allocation corresponds to a point on the two-dimension region of graph 3500. Noise power at the UE device receivers was set to 5×10⁻⁷W, and w₁ was set equal to w₂. Regions of graph 3500 other than to four corner points correspond to simultaneous downlink transmission to two UE devices and must be realized by either orthogonal multiple access (OMA) or NOMA. In this example, Applicant focused on NOMA as it on average outperforms OMA in the experimental setup. The optimal resource allocations of graph 3500 were derived from brute force searches over the entire two-dimension region of graph 3500. It should be noted that the objective function g(η_{τ}), as aforementioned, is not continuous over the search region encompassed by graph 3500.

As an alternative to the brute force approach corresponding to graph 3500, Applicant limited the search subspace using an embodiment of the new methods for simplification of resource allocation in a communication network, henceforth referred to as “the proposed simplification method” for brevity. The proposed simplification method limited the search space to two of the four edges of graph 3500 by applying comparative advantage using mathematical expressions (28) and (29) below.

$${f}_{1 , 1} = 0 \& 0 \leq {f}_{1 , 2} \leq 1 ⋃ 0 \leq {f}_{1 , 1} \leq 1 \& {f}_{1 , 2} = 1 if \vert \frac{{h}_{1 , 1}}{{h}_{1 , 2}} \vert < \vert \frac{{h}_{2 , 1}}{{h}_{2 , 2}} \vert \qquad ( 28 )$$

$${f}_{1 , 1} = 1 \& 0 \leq {f}_{1 , 2} \leq 1 ⋃ 0 \leq {f}_{1 , 1} \leq 1 \& {f}_{1 , 2} = 0 if \vert \frac{{h}_{1 , 1}}{{h}_{1 , 2}} \vert > \vert \frac{{h}_{2 , 1}}{{h}_{2 , 2}} \vert \qquad ( 29 )$$

Experimental results showed that the proposed simplification method performed well. In particular, results showed that in 90 percent of 10,000 simulated instances, the proposed simplification method converged to the global optimum regardless of its limited search space, i.e. reducing the search space from two-dimensions to one-dimension, when w₁=w₂. Additionally, the experimental results showed that in 92 percent of 10,000 simulated instances, the proposed simplification method converged to the global optimum when w₁=2w₂. Applicant also changed the noise power to see how it impacted this percentage, as shown in a graph 3600 of FIG. 36 which plots receiver noise power versus percentage of simulation instances where a proposed simplification method achieved a global optimum resource allocation. As shown by graph 3600, a noisier channel/receiver, or a lower SNR, generally resulted in greater alignment between the suboptimum allocation provided by the proposed simplification method and the global optimum resource allocation.

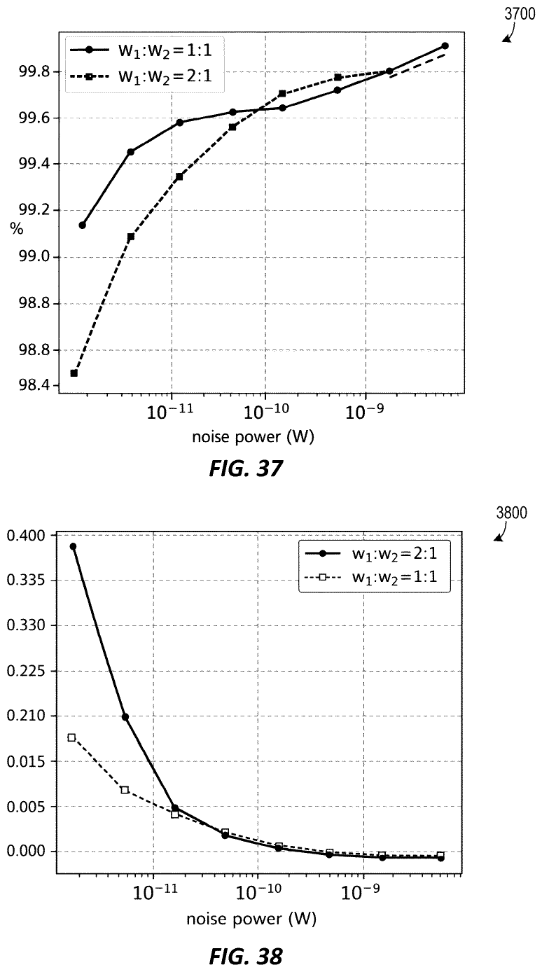

In fact, when a global optimum happens to lie on any of the four edges of graph 3500 of FIG. 35, this global optimum can very likely be found by the proposed simplification method (which only checks two of the four edges of graph 3500), and this likelihood is greater than 99.2% when w₁=w₂, and greater than 98.5% when w₁=2w₂, over the simulated, and practical, receiver noise powers. The results can be observed from FIG. 37, which is a graph 3700 of receiver noise power versus percentage of simulation instances having global optimums on the four edges of graph 3500 using the proposed simplification method.

As can be seen in FIG. 35, many optimal allocations are offset from the graph edges and hence cannot be included in the reduced sub-space described by the proposed simplification method. However, the values of the objective function g(η_{τ}) at these optimums are not far off from the values of the objective function g(η_{τ}) at the sub-optimums provided by the proposed simplification method. For example, see FIG. 38, which is a graph 3800 of receiver noise power versus average degradation of the objective function value provided by the proposed simplification method compared with simulated value of the objective function at its global optimum. It can be seen in FIG. 38 that the average degradation from the proposed simplification method with respect to simulated global optimum is less than 0.04% in a worst scenario. The results show that the proposed simplification method is an effective way to reduce the search space of power allocation with a minimal number of outliers.

Furthermore, experimental results showed that a value of the quantifying variable α from equation (18) can be used to predict whether the result given by the proposed simplification method is materially different from the global optimum. In particular, experimental results showed that value of quantifying variable α from equation (18) can be used to distinguish between (a) cases where the result achieved by the proposed simplification method is exactly the global optimum, i.e. the global optimum lies inside the reduced search space and (b) cases where the result achieved by the proposed simplification method is sub-optimal, i.e. the global optimum lies outside the reduced search space, especially at low SINR. As a result, a simplification system can use quantifying variable α to decide whether to use the proposed simplification method on a resource allocation by resource allocation instance. For example, when noise power is 5×10⁻⁹ W, the proposed simplification method is likely to give the global optimum when quantifying variable α is above 0.7, while the proposed simplification method is likely to give a sub-optimum result, but with a low degradation, when quantifying variable ais below 0.7.

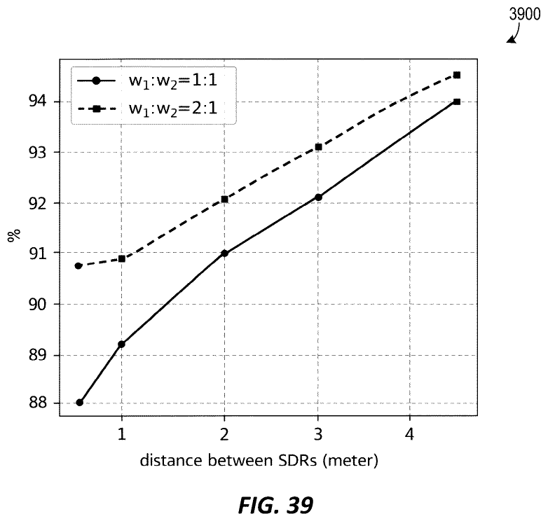

Applicant also verified the proposed simplification method using two National Instrument USRP-2954R software defined radio (SDR) setups, each equipped with two transceivers. One SDR setup emulated two CoMP wireless base stations, while the other SDR setup acted as two NOMA UE devices. The wireless base station SDR setup antennas were separated by 1.5 m to represent two distinct wireless base stations, whereas the UE device SDR setup antennas were separated by 2 m, with their positions varied relative to the wireless base station SDR setup. The OFDM signal of the SDR setups was configured with a 20 MHz bandwidth and 15 kHz subcarrier spacing, operating in a testing-licensed band. Channel estimates across all subcarriers were used to compute both the global optimum and the optimum produced by the proposed simplification method. FIG. 39 is a graph 3900 of distance between the two SDR setups versus a percentage of tested samples from the proposed simplification method that achieved a global optimum resource allocation. The data of FIG. 39 demonstrates that the percentage of cases where the proposed simplification method achieves the global optimum as a function of the wireless base station to UE device distance closely followed the simulated trend in FIG. 35 and remained consistently high.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method for simplification of resource allocation in a wireless communication network including a first client, a second client, a first wireless serving device, and a second wireless serving device, the method comprising:
obtaining a plurality of channel estimates from the wireless communication network, each channel estimate being associated with a respective resource allocation of a matrix of a plurality of feasible resource allocations;
for each of the first client and the second client, forming a respective comparative advantage ratio for the client that is an absolute value of a ratio of (1) a channel estimate of the plurality of channel estimates representing response of a communication channel between the client and the first wireless serving device and (2) a channel estimate of the plurality of channel estimates representing response of a communication channel between the client and the second wireless serving device;
determining relative values of the respective comparative advantage ratios for the first client and the second client; and
in response to a value of the respective comparative advantage ratio for the first client being greater than a value of the respective comparative advantage ratio for the second client, modifying the matrix of the plurality of feasible resource allocations to obtain a simplified resource allocation matrix at least partially by either (1) setting to zero a resource allocation to the second wireless serving device corresponding to the respective comparative advantage ratio for the first client or (2) setting to zero a resource allocation to the first wireless serving device corresponding to the respective comparative advantage ratio for the second client.

2. The method of claim 1, further comprising transmitting the simplified resource allocation matrix to an optimization system for use by the optimization system in determining an optimum allocation of communication resources in the wireless communication network.

3. The method of claim 1, wherein the matrix of the plurality of feasible resource allocations represents allocation of transmission power to each of the first wireless serving device and the second wireless serving device for each of the first client and the second client.

4. The method of claim 1, wherein the matrix of the plurality of feasible resource allocations represents allocation of wireless spectrum to each of the first wireless serving device and the second wireless serving device for each of the first client and the second client.

5. The method of claim 1, wherein the matrix of the plurality of feasible resource allocations represents allocation of transmission time to each of the first wireless serving device and the second wireless serving device for each of the first client and the second client.

6. The method of claim 1, wherein:
the wireless communication network operates according to a Third Generation Partnership Project (3GPP) standard;
each of the first client and the second client is a respective user equipment (UE) device; and
each of the first wireless serving device and the second wireless serving device is a respective wireless base station.

7. The method of claim 1, wherein:
the wireless communication network operates according to an Institute of Electrical and Electronics Engineers (IEEE) 802.11 standard;
each of the first client and the second client is a respective user station; and
each of the first wireless serving device and the second wireless serving device is a respective wireless access point (AP).

8. A method for simplification of resource allocation in a wireless communication network including N clients, a first wireless serving device, and a second wireless serving device, N being an integer greater than one, the method comprising:
obtaining a plurality of channel estimates from the wireless communication network, each channel estimate being associated with a respective resource allocation of a matrix of a plurality of feasible resource allocations;
for each client of the N clients, forming a respective comparative advantage ratio that is an absolute value of a ratio of (1) a channel estimate of the plurality of channel estimates representing response of a communication channel between the client and the first wireless serving device and (2) a channel estimate of the plurality of channel estimates representing response of a communication channel between the client and the second wireless serving device;
forming an ordered list of comparative advantage ratios by ordering the respective comparative advantage ratios of the N clients in one of a descending order and an ascending order, each comparative advantage ratio of the ordered list having a respective index q where q ranges from 1 to N;
determining a boundary index value I of the ordered list where an optimal resource allocation switches from allocating communication resources to the first wireless serving device to allocating communication resources to the second wireless serving device when optimizing an objective function characterizing the wireless communication network, either the objective function or a negative of the objective function satisfying Inada conditions; and
modifying the matrix of the plurality of feasible resource allocations to obtain a simplified resource allocation matrix at least partially by (1) setting to zero each resource allocation to the second wireless serving device corresponding to a comparative advantage ratio of the ordered list with a respective index q value that is less than the boundary index value I and (2) setting to zero each resource allocation to the first wireless serving device corresponding to a comparative advantage ratio of the ordered list with a respective index q value that is greater than boundary index value I.

9. The method of claim 8, further comprising transmitting the simplified resource allocation matrix to an optimization system for use by the optimization system in determining an optimum allocation of communication resources in the wireless communication network.

10. The method of claim 8, wherein the objective function represents a maximum transmission time in the wireless communication network.

11. The method of claim 8, wherein the matrix of the plurality of feasible resource allocations represents allocation of transmission power to each of the first wireless serving device and the second wireless serving device for each of the N clients.

12. The method of claim 8, wherein the matrix of the plurality of feasible resource allocations represents allocation of wireless spectrum to each of the first wireless serving device and the second wireless serving device for each of the N clients.

13. The method of claim 8, wherein the matrix of the plurality of feasible resource allocations represents allocation of transmission time to each of the first wireless serving device and the second wireless serving device for each of the N clients.

14. The method of claim 8, wherein:
the wireless communication network operates according to a Third Generation Partnership Project (3GPP) standard;
each of the N clients is a respective user equipment (UE) device; and
each of the first wireless serving device and the second wireless serving device is a respective wireless base station.

15. The method of claim 8, wherein:
the wireless communication network operates according to an Institute of Electrical and Electronics Engineers (IEEE) 802.11 standard;
each of the N clients is a respective user station; and
each of the first wireless serving device and the second wireless serving device is a respective wireless access point (AP).

16. A method for simplification of resource allocation in a wireless communication network including a first client, a second client, a first wireless serving device, and a second wireless serving device, the method comprising:
obtaining channel estimates h_{1,1}, h_{1,2}, h_{2,1}, and h_{2,2} from the wireless communication network, h_{1,1} representing response of a communication channel between the first client and the first wireless serving device, h_{1,2} representing response of a communication channel between the first client and the second wireless serving device, h_{2,1} representing response of a communication channel between the second client and the first wireless serving device, and h_{2,2} representing response of a communication channel between the second client and the second wireless serving device;
determining a quantifying variable α, where
$$α = \vert \frac{{\vert {h}_{1 , 1} {h}_{2 , 2} \vert}^{2} - {\vert {h}_{1 , 2} {h}_{2 , 1} \vert}^{2}}{{\vert {h}_{1 , 1} {h}_{2 , 2} \vert}^{2} + {\vert {h}_{1 , 2} {h}_{2 , 1} \vert}^{2}} \vert ;$$
comparing a value of α to a predetermined minimum threshold value; and
in response to the value of α being at least the predetermined minimum threshold value, modifying a matrix of a plurality of feasible resource allocations to obtain a simplified resource allocation matrix.

17. The method of claim 16, wherein:
the matrix of a plurality of feasible resource allocations is a matrix F, wherein:
$$F = \begin{matrix}{f}_{1 , 1} & {f}_{1 , 2} \\ {f}_{2 , 1} & {f}_{2 , 2}\end{matrix} ,$$
f_{1,1} is a resource allocated to the first wireless serving device for serving the first client,
f_{1,2} is a resource allocated to the second wireless serving device for serving the first client,
f_{2,1} is a resource allocated to the first wireless serving device for serving the second client, and
f_{2,2} is a resource allocated to the second wireless serving device for serving the second client; and
modifying the matrix of the plurality of feasible resource allocations to obtain the simplified resource allocation matrix comprises, in response to
$$\vert \frac{{h}_{1 , 1}}{{h}_{1 , 2}} \vert > \vert \frac{{h}_{2 , 1}}{{h}_{2 , 2}} \vert , \qquad ( a )$$
setting f_{1,2} to zero and (b) setting f_{2,2} to one.

18. The method of claim 16, wherein:
the matrix of a plurality of feasible resource allocations is a matrix F, wherein:
$$F = \begin{matrix}{f}_{1 , 1} & {f}_{1 , 2} \\ {f}_{2 , 1} & {f}_{2 , 2}\end{matrix} ,$$
f_{1,1} is a resource allocated to the first wireless serving device for serving the first client,
f_{1,2} is a resource allocated to the second wireless serving device for serving the first client,
f_{2,1} is a resource allocated to the first wireless serving device for serving the second client, and
f_{2,2} is a resource allocated to the second wireless serving device for serving the second client; and
modifying the matrix of the plurality of feasible resource allocations to obtain the simplified resource allocation matrix comprises, in response to
$$\vert \frac{{h}_{1 , 1}}{{h}_{1 , 2}} \vert > \vert \frac{{h}_{2 , 1}}{{h}_{2 , 2}} \vert ,$$
(a) setting f_{2,1} to zero and (b) setting f_{1,1} to one.

19. The method of claim 16, wherein:
the matrix of a plurality of feasible resource allocations is a matrix F, wherein:
$$F = \begin{matrix}{f}_{1 , 1} & {f}_{1 , 2} \\ {f}_{2 , 1} & {f}_{2 , 2}\end{matrix} ,$$
f_{1,1} is a resource allocated to the first wireless serving device for serving the first client,
f_{1,2} is a resource allocated to the second wireless serving device for serving the first client,
f_{2,1} is a resource allocated to the first wireless serving device for serving the second client, and
f_{2,2} is a resource allocated to the second wireless serving device for serving the second client; and
modifying the matrix of the plurality of feasible resource allocations to obtain the simplified resource allocation matrix comprises, in response to
$$\vert \frac{{h}_{2 , 1}}{{h}_{2 , 2}} \vert > \vert \frac{{h}_{1 , 1}}{{h}_{1 , 2}} \vert ,$$
(a) setting f_{2,2} to zero and (b) setting f_{1,2} to one.

20. The method of claim 16, wherein:
the matrix of a plurality of feasible resource allocations is a matrix F, wherein:
$$F = \begin{matrix}{f}_{1 , 1} & {f}_{1 , 2} \\ {f}_{2 , 1} & {f}_{2 , 2}\end{matrix} ,$$
f_{1,1} is a resource allocated to the first wireless serving device for serving the first client,
f_{1,2} is a resource allocated to the second wireless serving device for serving the first client,
f_{2,1} is a resource allocated to the first wireless serving device for serving the second client, and
f_{2,2} is a resource allocated to the second wireless serving device for serving the second client; and
modifying the matrix of the plurality of feasible resource allocations to obtain the simplified resource allocation matrix comprises, in response to
$$\vert \frac{{h}_{2 , 1}}{{h}_{2 , 2}} \vert > \vert \frac{{h}_{1 , 1}}{{h}_{1 , 2}} \vert ,$$
a) setting f_{1,1} to zero and (b) setting f_{2,1} to one.
